(19) United States
(12) Patent Application Publication
(10) Pub. No.: US 2009/0041215 A1
(43) Pub. Date: Feb. 12, 2009

(54) System and method for IVR development

(75) Inventors: Michael Schmitt, Plymouth, MN (US); Nicole Holte, Plymouth, MN (US); Jeffrey Clement, Maple Grove, MN (US); Matt Weyland, Crystal, MN (US); Eric Pilhofer, Minnetonka, MN (US); Roman Loy, Eden Prairie, MN (US)

Correspondence Address: SCHWEGMAN, LUNDBERG & WOESSNER, P.A., P.O. BOX 2938, MINNEAPOLIS, MN, 55402, US

(73) Assignee: MA Capital LLLP

(21) Appl. No.: 11/891,231

(22) Filed: Aug. 9, 2007

(51) Int. Cl. H04M 1/64; G10L 13/00

(52) U.S. Cl. 379/88.17; 379/88.18; 704/258; 704/E13.001

(57) ABSTRACT

In one embodiment, a system and method is illustrated as including creating a visual script containing a component that includes at least one of a function component, a decisional component, a speak component, and a capture component, and converting the visual script to a computer script. Further, this system and method may include retrieving a computer script from a pre-populated database, the computer script containing at least one component and being formatted using a language including at least one of an IVR-XML and a character delimited flat file, and generating training data using the computer script, the training data formatted as a linear computer script.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots which may be illustrated below and in the drawings that form a part of this document: Copyright ©2007, Marketing Architects, Incorporated. All Rights Reserved.

### TECHNICAL FIELD

The present application relates generally to the technical field of algorithms and programming and, in one specific example, to generate scripts for Interactive Voice Response (IVR) based systems.

### BACKGROUND

Interactive voice response is used to automate or augment many of the business processes engaged in by call centers. For example, an IVR-based system may be used to guide a potential customer through a series of purchase options, help options, or other options that may be used to facilitate the purchase of a good or service. Common to these IVR systems is the wedding of logic to some type of audio signal such as voice.

### BRIEF DESCRIPTION OF THE DRAWINGS

Some embodiments are illustrated by way of example and not limitation in the figures of the accompanying drawings in which:

FIG. 1 is a diagram of a system illustrating the environment for an IVR system, according to an example embodiment.

FIG. 2 is a diagram of a system for generating an IVR script, according to an example embodiment.

FIG. 3 is a diagram of a system illustrating the generation of an Interactive Voice Response-eXtensible Markup Language (IVR-XML) script that also utilizes an audio file, according to an example embodiment.

FIG. 4 is a diagram of a system for allowing a script generator to conduct a test call, according to an example embodiment.

FIG. 5 is a diagram of a script Integrated Development Environment (IDE) showing the various components that may be used to make up a script and a description thereof, according to an example embodiment.

FIG. 6 is a diagram of a script IDE showing a dynamic speak component and a description thereof, according to an example embodiment.

FIG. 7 is a diagram of a script IDE showing a variable speak component and a description thereof, according to an example embodiment.

FIG. 8 is a diagram of a script IDE showing a collect information component 801, and a description thereof, according to an example embodiment.

FIG. 9 is a diagram of a script IDE showing a record component and a description thereof, according to an example embodiment.

FIG. 10 is a diagram of a script IDE showing a direct decisional component and a description thereof, according to an example embodiment.

FIG. 11 is a diagram of a script IDE showing an outcome component and a description thereof, according to an example embodiment.

FIG. 12 is a diagram of a script IDE showing a function component and a description thereof, according to an example embodiment.

FIG. 13 is a diagram of a script IDE showing a function component, the script underlying this component, and a description of this script and some of its associated components, according to an example embodiment.

FIG. 14 is an IDE showing the results of the execution of a script validator and/or tester, according to an example embodiment.

FIG. 15 is a diagram of an IVR-XML script, according to an example embodiment.

FIG. 16 is a diagram of a training set written in XML, according to an example embodiment.

FIG. 17 is a block diagram of a device, and the various blocks that may reside on this device, according to an example embodiment.

FIG. 18 is a block diagram of a script server, and the various blocks that may reside on this server, according to an example embodiment.

FIG. 19 is a tri-stream flowchart illustrating a method to generate an IVR-XML script and to implement this IVR-XML script on a network appliance, according to an example embodiment.

FIG. 20 is a flowchart illustrating a method used to execute an operation that creates components to be used to populate an IDE window, and to create associations between these components in the form of links, according to an example embodiment.

FIG. 21 is a flowchart illustrating a method used to execute an operation to link components using an Input/Output (I/O) device, according to an example embodiment.

FIG. 22 is a flowchart illustrating a method used to execute an operation that converts a script flow to an XML representation of the script flow, according to an example embodiment.

FIG. 23 is a flowchart illustrating a method used to execute an operation that parses IVR-XML script and stores it into a script database, according to an example embodiment.

FIG. 24 is a flowchart illustrating a method used to execute an operation that converts IVR-XML script to a linear routine, according to an example embodiment.

FIG. 25 is a dual-stream flowchart illustrating a method used to execute an operation that parses and interprets a training set, according to an example embodiment.

FIG. 26 is a flowchart illustrating a method used to store a record of a call, such as a call into a database, according to an example embodiment.

FIG. 27 is a flowchart illustrating a method to analyze the data contained in an OLAP database, according to an example embodiment.

FIG. 28 is a Relational Data Scheme (RDS) that may reside as a part of a script database, according to an example embodiment.

FIG. 29 is an example schema that may reside as a part of an On-Line Analytic Processing (OLAP) based database, according to an example embodiment.

FIG. 30 is a diagrammatic representation of a machine in the example form of a computer system, according to an example embodiment.

### DETAILED DESCRIPTION

In the following description, for purposes of explanation, numerous specific details are set forth in order to provide a thorough understanding of example embodiments. However, it may be evident to one skilled in the art that the present invention may be practiced without these specific details.

In some embodiments, a system and method is illustrated to facilitate the generation of IVR scripts written by a script generator such as a marketing or copywriting professional. These marketing or copywriting professionals may have little or no formal training when compared to, for example, software developers, in the generation of an IVR script. This said, the system and method illustrated herein allows these script generators to develop IVR scripts based upon the ease of use of this system and method. The ease of use allows these script generators to quickly and efficiently generate a new IVR script so as to respond to the ever-changing nature of a marketplace. More to the point, rather than having, for example, a marketing or copywriting professional generate a script as a written text, and then having a software developer, or other similarly trained professional, convert this written text into an IVR script, in one embodiment the marketing or copywriting professional generates the IVR script. Further, the script generator is also able to review the script as executed. By allowing, for example, marketing and copywriting professionals to generate scripts, changes in the marketplace environment can be responded to quickly to capitalize on or otherwise utilize marketing initiatives.

In some embodiments, an IDE designed for a script generator, such as a marketing or copywriting professional, is illustrated. This IDE allows a script generator to utilize, for example, a “drag and drop” method having various visual components such as a function component, a decisional component, a speak component, and/or a capture component to generate a visual representation of an IVR script. Using the drag and drop method in combination with the above-outlined components a marketing or copywriting professional may be able to generate this visual representation of an IVR script with little formal training. Further, certain validating features may be provided to the script generator to address problems such as script dead-ends and other run-time errors.

Some embodiments may include certain sub-types that may be associated with each of the components outlined above. For example, a speak component may be either a dynamic speak component or a variable speak component. A dynamic speak component may perform simplified text-to-speech conversion, while the variable speak component may use a recorded message alone or in combination with text-to-speech. Further, a decisional component may be either a direct decisional component or an outcome-based decisional component, where the direct decisional component functions akin to a conditional statement and the outcome-based component may be executed using return values provided by the network appliance (e.g., an IVR switch). Additionally, a capture component may be either a collect information component or a record component, where the collect information component collects information that may be provided via, for example, Dual Tone Multi-Frequency (DTMF) signaling (e.g., a telephone key pad), and the record component may record a message from a user (e.g., a caller).

Once a visual representation of an IVR script is generated, in some embodiments, it is converted into an IVR script using a formal language such as XML. This conversion process may be governed by, for example, an XML Document Schema (XSD) or a Document Type Definition (DTD). The resulting XML based IVR (XML-IVR) script may then be stored in a database (e.g., an SQLSERVER™ Database) for future use by, for example, an IVR network appliance such as a NORTEL™ IVR switch using PERIPRO™, or other suitable network appliance. In effect, in some embodiments, this XML-IVR script may be used to train the network appliance. This training may provide direction to the network appliance when responding to input, for example, where to direct an incoming phone call, what additional XML-IVR scripts may be called or otherwise retrieved for use, or any number of other suitable operations.

In some embodiments, various analyses may be performed on data relating to a particular script and the components that make up this script. For example, the outcome or result of using a particular script can be analyzed such that a probability value may be generated showing the probability that a script may result in an order, lead, or sale. In some embodiment, these probabilities may be generated using database technology including OLAP. These various analyses will be more fully illustrated below.

### Example IVR System

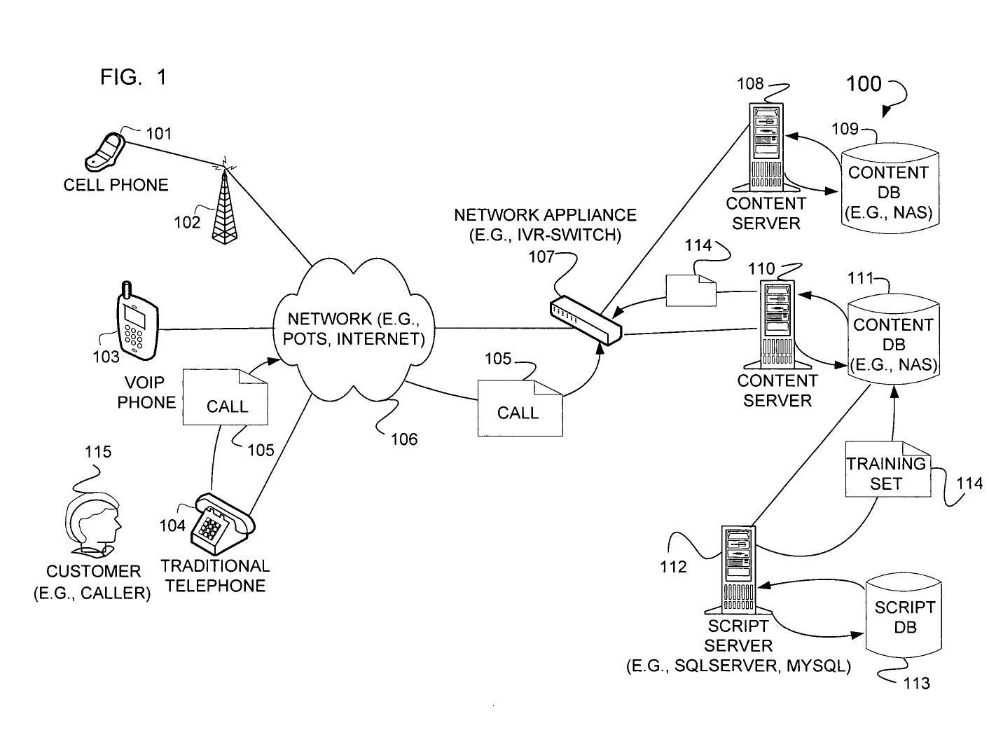

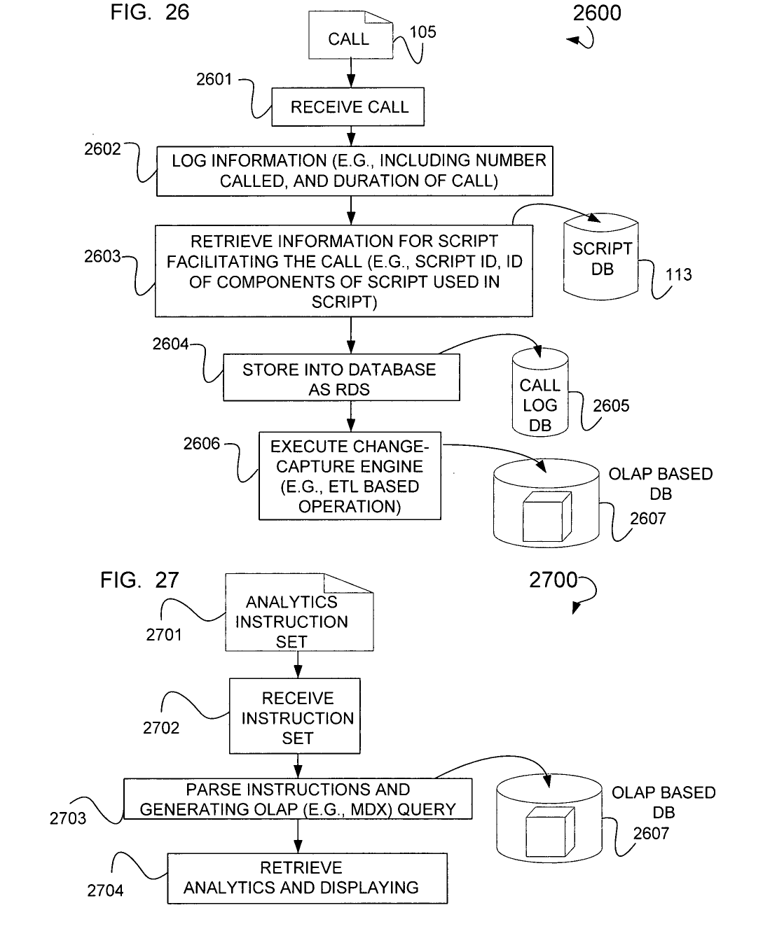

FIG. 1 is a diagram of an example system 100 illustrating the environment for an IVR system. Illustrated are a number of caller devices such as, for example, a cell phone 101 that is operatively connected to a transmitter 102, a Voice Over IP (VoIP) phone 103, and a traditional telephone 104. Any one of these example devices may be operated by, for example, a customer 115, who in this example functions as a caller. In one embodiment, a customer 115, utilizing a traditional telephone 104, makes a call 105 across a network 106. Network 106 may be, for example, a Plain Old Telephone Service (POTS) based system, an internet utilizing, for example, VoIP, or some other suitable type network for handling a telephonic call. Call 105 is transmitted across the network 106 to, for example, a network appliance 107. Network appliance 107 may be, for example, an IVR switch, or some other suitable network appliance utilized for the purposes of handling the call 105 in an IVR environment. Network appliance 107 may, in some embodiments, receive a training set 114 generated and transmitted by a content server 110. Connected to the content server 110 is a content database 111 (e.g., a Network Area Storage (NAS) device) that is operatively connected to a script server 112 having a script database 113. In some cases, this script database 113 may be a pre-populated database, such that scripts are retrieved from the script database 113 on an as needed basis. In some embodiments, script server 112 may have a database application running on top of it including, for example, SQL SERVER™, MYSQL™, or some other suitable database application. In some cases, a separate database server or servers may be operatively coupled to the script server 112. In either embodiment, script server 112, or alternatively a database server, may be able to manage a traditional RDS based database that utilizes a Structured Query Language (SQL) to make queries. Further, it may be able to manage an OLAP-based database that uses a Multidimensional Expression (MDX) to generate queries (see FIGS. 26-27 and 29). Training set 114 may contain, for example, instructions for setting up the script for performing a particular IVR response. In some cases, network appliance 107 may also be operatively connected to a plurality of content servers, such as content server 108 having a content database 109, and content server 110 having content database 111. These content servers may also serve up digital content in the form of voice recordings or other types of digital content that may be useful during the course of executing an IVR script.

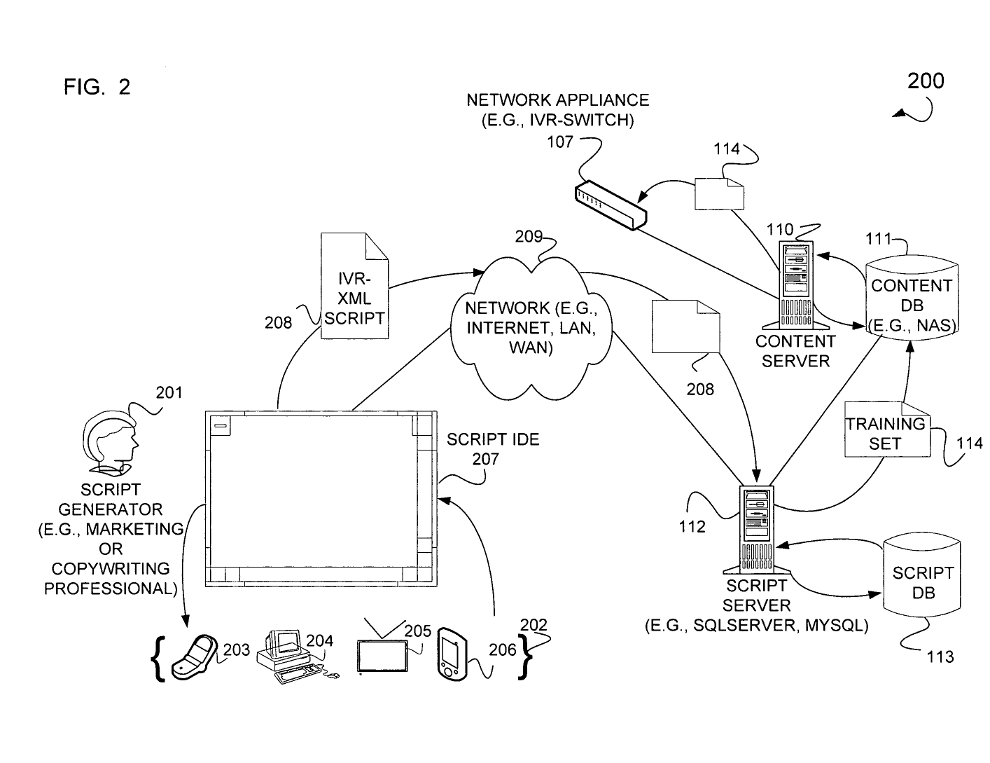

FIG. 2 is a diagram of an example system 200 for generating an IVR script. Illustrated is a script generator 201 who, utilizing any one of a number of devices 202, may generate a computer script (e.g., a script written in a language readable by computer system) such as an IVR-XML script. In some embodiments, this IVR-XML script is written in XML or some other suitable markup language. In other embodiments, this script is written as a character-delimited flat file. The one or more devices 202 may include, for example, a cell phone 203, a computer system 204, a television 205, and/or a Personal Digital Assistant (PDA) 206. Residing as a part of, or on top of, these one or more devices 202 may be, for example, a script IDE 207 that may be utilized by the script generator 201. In one embodiment, the script generator 201, utilizing the script IDE 207, may generate an IVR-XML script 208. IVR-XML script 208 may be transmitted across a network 209, for example, an internet, a Local Area Network (LAN), a Wide Area Network (WAN), or some other suitable network. Once transmitted across the network 209, the IVR-XML script 208 may be received by, for example, the previously-illustrated script server 112. Once received by the script server 112, IVR-XML script 208 may be stored into a script database 113. In some cases, IVR-XML script 208 may be parsed and compiled and/or combined into the previously-illustrated training set 114. Training set 114 may then be transmitted to the content database 111 and/or the content server 110 to be served to the network appliance 107.

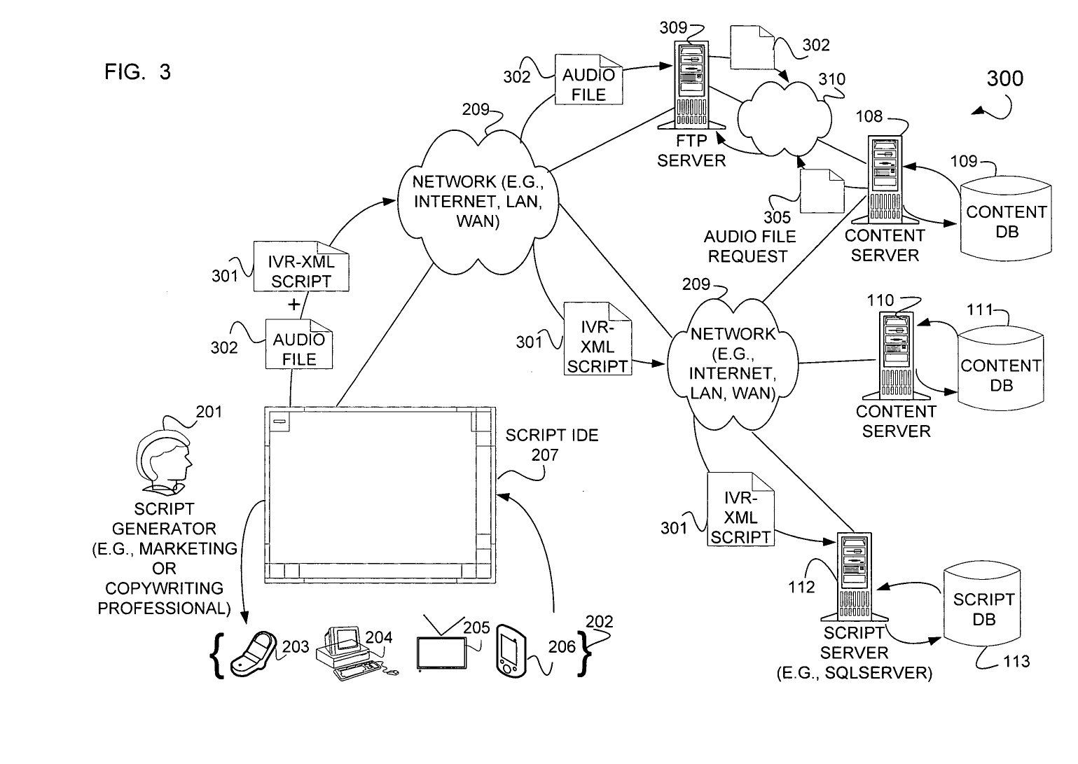

FIG. 3 is a diagram of an example system 300 illustrating the generation of an IVR-XML script that also utilizes an audio file. Illustrated is the previously-shown script generator 201 who utilizes a script IDE 207 to generate an IVR-XML script 301 and an accompanying audio file 302. IVR-XML script 301 and audio file 302 may, in some cases, be transmitted across the network 209. The IVR-XML script 301 may be received by the script server 112 and stored into a database 113, while the audio file 302 may be received by a File Transfer Protocol (FTP) based server (e.g., FTP server 309) and stored into a database (not pictured) operatively connected to FTP server 309. In some embodiments, FTP server 309 may then be queried by the content server 108 via an audio file request 305 sent across a network 310. Network 310 may be an internet, LAN, WAN, or other suitable network. In response to the audio file request 305, the audio file 302 may be provided to the content server 108. Audio file 302 may then be sent on to the network appliance 107 for use (e.g., playing). In some embodiments, the audio file may be streamed to the network appliance 107 by the content server 108 as a media stream.

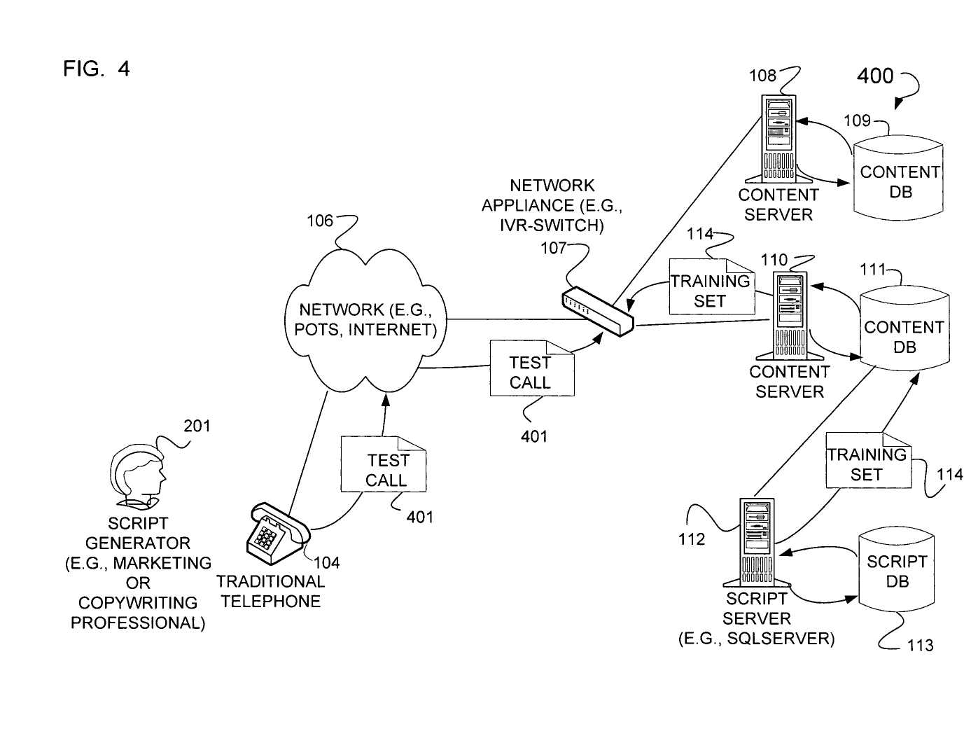

FIG. 4 is a diagram of an example system 400 for allowing a script generator 201 to conduct a test call. Illustrated is a script generator 201 who, utilizing a traditional telephone 104, may generate a test call 401. Test call 401 may be made across, for example, the previously-illustrated network 106. Once the test call 401 is sent across the network 106, it may be received by, for example, the network appliance 107. Network appliance 107 may be trained with a training set 114 that may be generated as a result of the previously-illustrated IVR-XML script 301.

### Example Interfaces and IDE

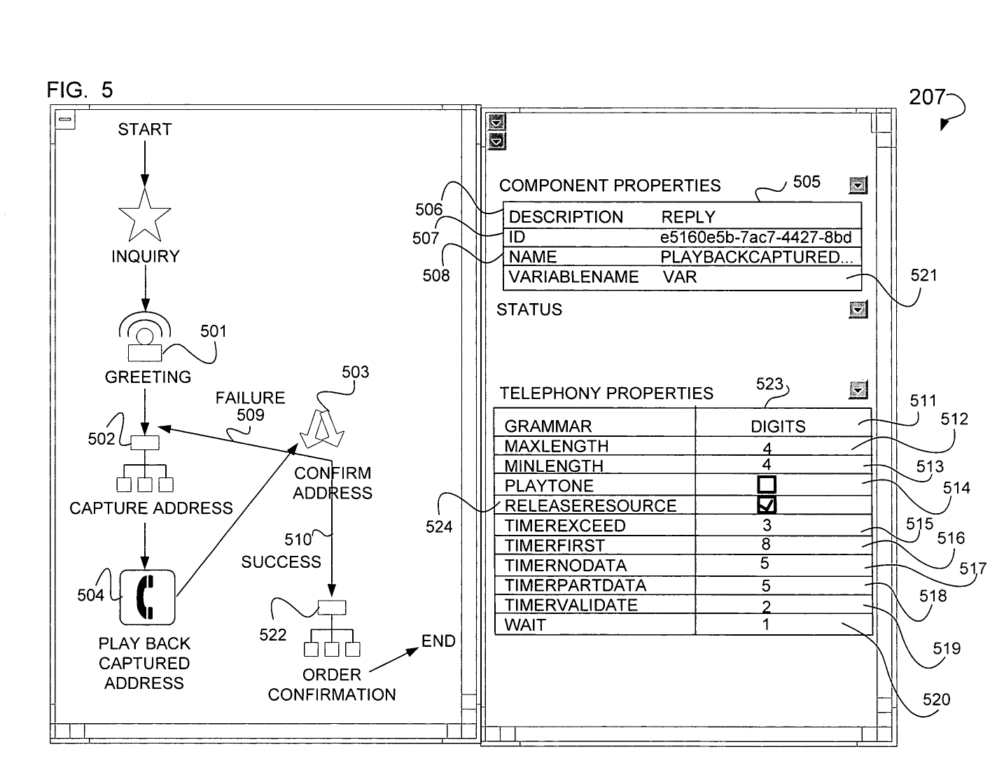

FIG. 5 is a diagram of an example script IDE 207 showing the various components that may be used to make up a script and a description of these components. Shown is a script IDE 207 containing a number of iconic representations of components. For example, a speak component 501 titled “Greeting” is linked to a function component 502 titled “Capture Address”. Function component 502 is, in turn, linked to a variable speak component 504 titled “Playback Captured Address”, which is, in turn, linked to a direct decisional component 503 titled “Confirm Address”. In cases where the direct decisional component 503 evaluates to “failure” (e.g., false) 509, the function component 502 is re-executed. In cases where direct decisional component 503 evaluates to “success” (e.g., true) 510, a function component 522 titled “Order Confirmation” is executed. As to the speak component 501, in some cases this is an audio recording of a greeting, such that when a customer, such as customer 115, makes an inquiry or call, the IVR system responds by playing a greeting (e.g., executing the speak component 501). In some cases, the customer 115 making the call may be asked to provide address information. This address information may be captured by, for example, the execution of the function component 502, such that function component 502 records the audio signals generated by the customer 115 during the course of making a call. Once the recording is made by, for example, the customer 115, the customer 115 may have the option of playing back the provided address information. The variable speak component 504, when executed, may play back this address information. Once playback occurs, the customer 115 may have the option of confirming the success or failure of the captured address (e.g., the recorded address). In cases where a failure of the captured address is asserted (e.g., failure 509), the function component 502 is re-executed, and the customer 115 is asked to re-record their address. In cases where the address is successfully captured (e.g., success 510), then an additional component could, for example, be executed (e.g., function component 522).

Some example embodiments may include, as a part of the script IDE 207, a description of the various components that make up the script. For example, a component's properties window 505 may contain a description of a particular component (e.g., in FIG. 2 the variable speak component 504 is described) that makes up part of a particular script. For example, a description of the component as illustrated in field 506 may provide a verbose description of the component. Next, field 507 provides a uniquely identifying value for this component. In some cases uniquely identifying value may be a Globally Unique ID (GUID) value (e.g., a 128 bit value), such that each component has a globally unique identifier value associated with it, and wherein no two components can have the same identifier value. This GUID value may serve as a universal reference identifier for a component. Further, field 508 may provide a label name for the component. Also illustrated is a field 521 containing a variable name used to reference the component. Further, for all components a further field may be provided to illustrate a use privilege for a script generator 201 to check in or check out a component for a particular script they might be writing.

In some embodiments, the particular telephony properties of a script and/or a component are also provided. Illustrated is a telephony properties window 523 showing a number of data fields. Field 511 contains a description of the type of grammar that may be used to process data being provided to the script. This grammar may define how to process voice or text data provided by a customer 115. Field 512 contains maximum length data relating to the maximum length in seconds, minutes, or some other suitable measure of time of a voice message left by a customer 115. Field 513 contains the minimum length of a message provided by a customer 115 in terms of some unit of time. Field 514 illustrates a boolean value in the form of a check box that allows a script generator 201 to select whether a play time may be provided for the script. Field 524 shows a boolean value in the form of a check box that allows a script generator 201 to determine whether the source code underlying the script should be made accessible to others. Field 515 shows a timer value for how much time a customer 115 has to leave a message beyond an allotted time. In this example, the value is set to 3, denoting some unit of time. Field 516 shows a timer value for how much time a customer is allotted to leave a message after they say their first word for the message. The value in field 516 is set to 8 as a unit of time. Field 517 is a field containing a timer value for the longest period of time that no voice data may be provided by a customer 115 after any word is spoken, while still maintaining the ability to provide data to be recorded (e.g., how long they may be silent). Field 518 is a timer value for the longest unit of time that a customer 115 may be allotted in which to provide at least half of the requested data, where this requested data is numeric data or some other predefined data. Field 519 is a timer value for validating, wherein a predetermined time unit is set for the length of time a customer 115 is allotted in which to validate the provided data. Field 520 shows a unit of time denoting how long a customer must wait to provide voice data after an initial prompt.

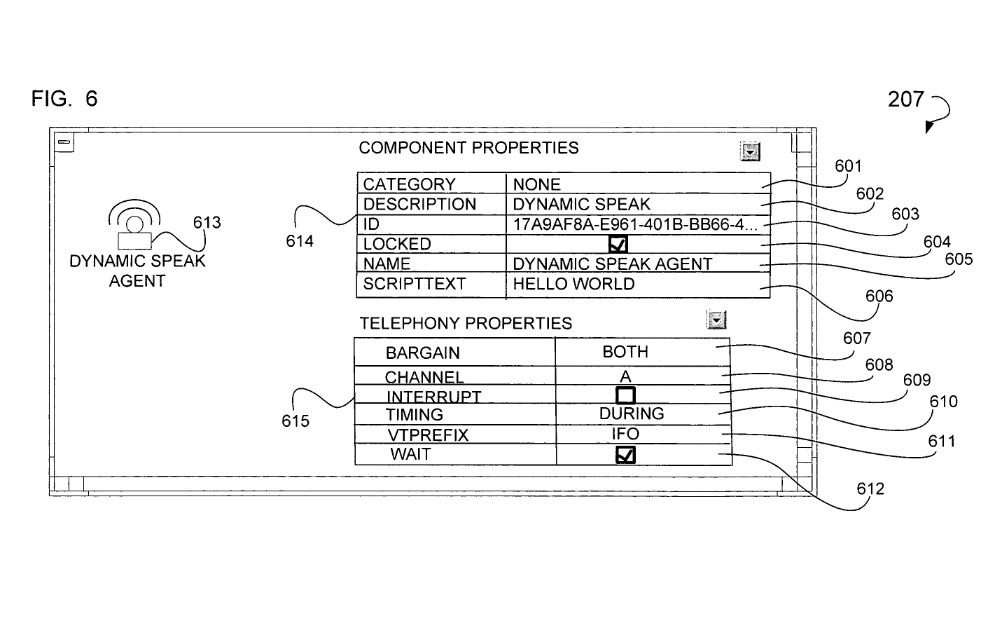

FIG. 6 is a diagram of an example script IDE 207 showing a dynamic speak component 613 and a description of this component. Illustrated are a component properties window 614 and a telephony properties window 615. Component properties window 614 contains a number of fields. Field 601 contains the category with which the dynamic speak component 613 is associated. This category may be a taxonomy illustrating how to group the component. Here the value is set to “None”, denoting that the dynamic speak component 613 is not part of a group. In some embodiments, this field 601 may be blank, in lieu of stating “None”. Field 602 contains a description of the component, here described as “Dynamic Speak”. Field 603 illustrates a GUID value for the dynamic speak component 613. Field 604 illustrates whether or not the dynamic speak component 613 may be modified. Here a check box (e.g., a boolean value) is set to “true”, such that the dynamic speak component 613 may not be modified. Field 605 contains the actual proper name for the component, which is “Dynamic Speak Agent”. Field 606 contains the text that may be used by the dynamic speak component 613 via a text-to-speech application, such that the words “Hello World” may be spoken to a customer 115 when the dynamic speak component 613 is executed.

Some example embodiments may include a telephony properties window 615 outlining various telephony properties that might be used in conjunction with the dynamic speak component 613. Field 607 shows whether a bargaining process must take place between a caller device (e.g., traditional telephone 104), and the network appliance 107 device prior to use of the dynamic speak component 613. Field 608 denotes the channel (e.g., a voice channel) on which data must be received for the dynamic speak component 613 to execute properly. Field 609 uses a check box (e.g., a boolean value) to display whether the data provided to the dynamic speak component 613 may be interrupted. Field 610 denotes how timing of the data provided to the dynamic speak component 613 may be provided. In this example, the timing of the provided data will take place during the execution of the dynamic speak component 613. Field 611 denotes a Voice Terminal (VT) prefix value, here set to IFO. Field 612 contains a check box (e.g., a boolean value) used to determine whether a pause will be provided prior to the customer 115 providing information to the dynamic speak component 613.

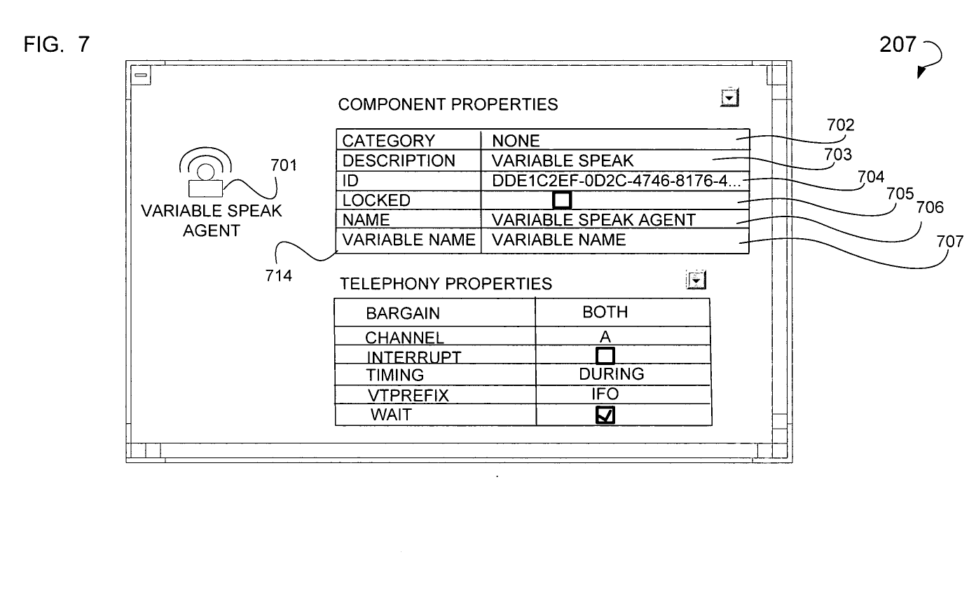

FIG. 7 is a diagram of an example script IDE 207 showing a variable speak agent 701 (e.g., a variable speak component) and a description of this component. Illustrated is a component properties window 714. Field 702 denotes a category to which this variable speak component 701 belongs, which in this case is “None”. Field 703 provides a description of variable speak component 701 as “variable speak”. Field 704 shows a GUID value for the variable speak component 701. Field 705 illustrates a check box for determining whether the variable speak component 701 is locked (e.g., not able to be modified; see field 604 above). Field 706 denotes the proper name of the variable speak component 701, which in this example is “Variable Speak Agent”. Field 707 provides a variable name in the form of “Variable name”, wherein this variable name is a second reference name for the variable speak component 701.

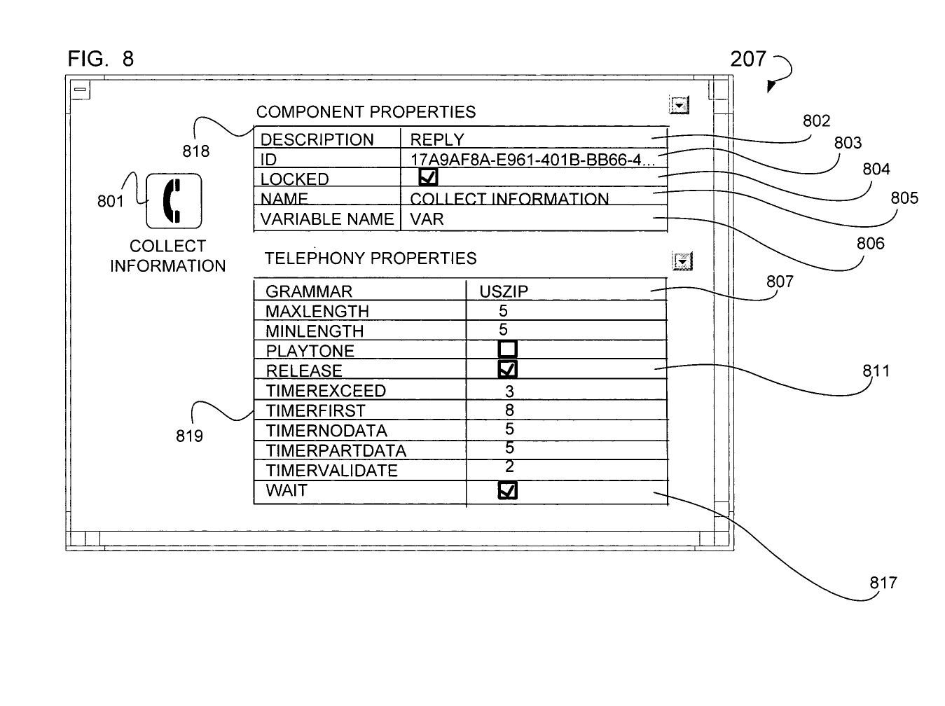

FIG. 8 is a diagram of an example script IDE 207 showing a collect information component 801 and a description of this component. Illustrated are a component properties window 818 and a telephony properties window 819. With regard to component properties window 818, field 802 shows a description of the collect information component 801, wherein the collect information component 801 collects information as a reply to an information request posed by the IVR system to a customer 115. Field 803 is the GUID value for the collect information component 801. Field 804 is a check box value (e.g., a boolean value) denoting whether the collect information component 801 may be modified. Field 805 illustrates the formal name of the collect information component 801. Field 806 denotes a second reference name for the collect information component 801.

Some example embodiments may include a telephony properties window 819 having a number of fields (e.g., 807-817). Field 807 shows the name of a grammar that may be used by the network appliance 107. This grammar (e.g., USZIP) may be a grammar used to receive keypad, DTMF based information regarding a United States ZIP code, or may be a grammar used to process voice based data relating to a United States ZIP code (e.g., a customer 115 speaking their United States ZIP code to the IVR system). Field 811 illustrates a check box for determining whether the information collected by the collect information component 801 may be released outside of the IVR system to third parties. Field 817 illustrates a check box (e.g., a boolean value) used to determine whether a customer 115 may have to wait a predetermined amount of time to provide information to the collect information component 801.

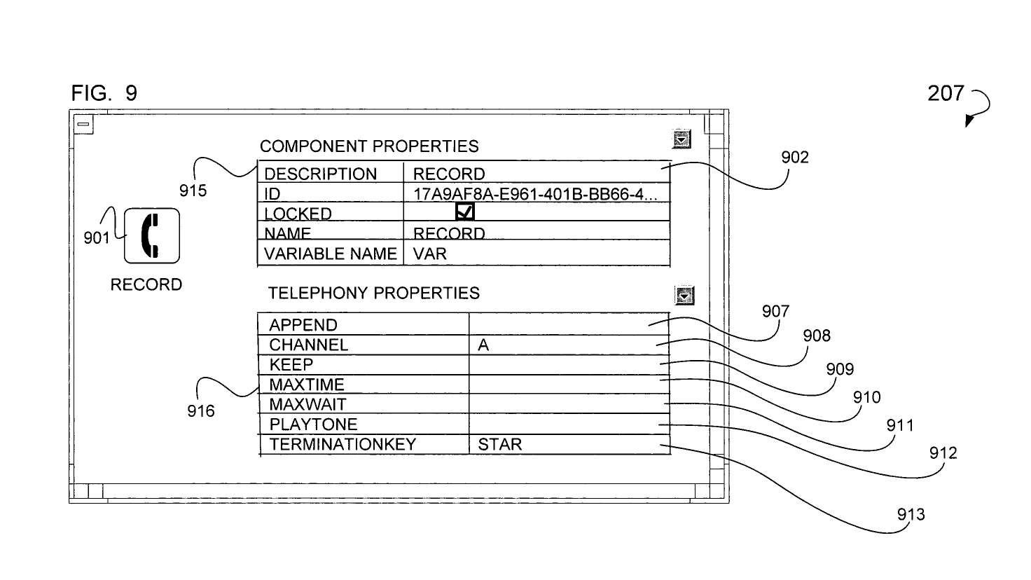

FIG. 9 is a diagram of an example script IDE 207 showing a record component 901 and a description of this component. Illustrated are a component properties window 915 and a telephony properties window 916. Component properties window 915 contains a field 902 for providing a description of the record component 901, which in this example is “record”. As previously stated, this description may be more or less verbose based upon the needs of the script generator 201. Telephony properties window 916 contains a number of fields for outlining the relationship between the record component 901 and the IVR system. Field 907 denotes whether a recorded message may be appended to by a customer 115. In some embodiments, a boolean value may be contained in this field. Field 908 denotes the channel that may be used by the record component 901 to receive data. Field 909 contains a keep value stating the length of time the recorded message should be kept for the purpose of determining staleness of the message. Field 910 denotes the maximum length of time that the record component 901 may record. Field 911 discloses the maximum length of time that a customer 115 must wait before using the record component 901. Field 912 takes a boolean value that determines whether a customer 115 hears a tone instructing them to provide a recording. Field 913 instructs a customer 115 on how to terminate a recording, which in this example is the use of the star (*) key.

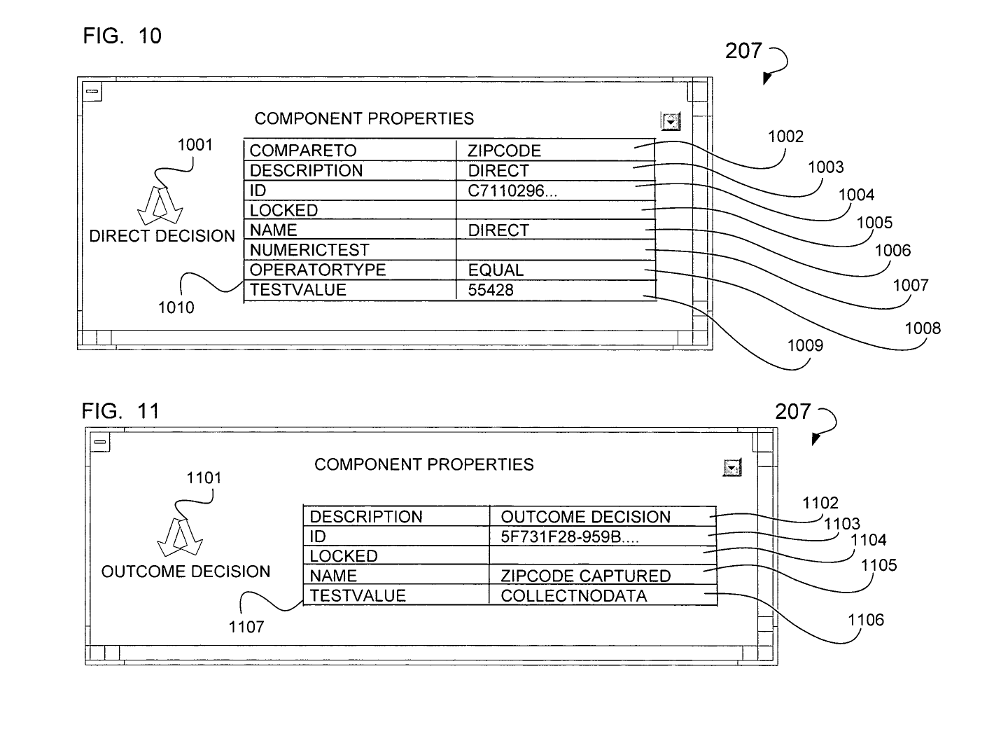

FIG. 10 is a diagram of an example script IDE 207 showing a direct decisional component 1001 and a description of this component. Illustrated is a component properties window 1010 containing a number of fields. These fields denote certain properties of the direct decisional component 1001. Field 1002 states what type of values are to be compared by the direct decisional component 1001, which in this example are ZIP codes. Field 1003 provides a verbose description of the direct decisional component 1001. Field 1004 discloses the GUID value. Field 1005 denotes whether the direct decisional component 1001 is locked against modification. Field 1006 provides the proper name for the direct decisional component 1001. Field 1007 provides information relating to whether a numeric test may be performed by the direct decisional component 1001 to test information. Field 1008 denotes the type of binary operator to be used in a conditional statement for the direct decisional component 1001. This binary operator may be, for example, less than (<), greater than (>), equal (=), not equal (!=), or some other suitable binary operator yielding a Boolean value. In some embodiments, a field 1009 is used to contain a test value for the direct decisional component 1001, such that all input values provided to the direct decisional component 1001 are compared against this test value using one or more of the above binary operators.

FIG. 11 is a diagram of an example script IDE 207 showing an outcome decision component 1101 and a description of this component. Illustrated is a component properties window 1107 containing a number of fields. Field 1102 contains a description of the outcome component 1101. Field 1103 contains a GUID value. Field 1104 contains a boolean value to denote whether the outcome component 1101 may be modified. Field 1105 illustrates the proper name of the outcome component 1101; in this example, the proper name (“ZIPCODE CAPTURE”) and the description (“Outcome Decision”) differ. These names differ in part based upon the fact that, in some embodiments, the context within which the outcome component 1101 appears may dictate the name by which the outcome component 1101 is referenced. Field 1106 illustrates the type of data to be used to test an outcome. In this example, field 1106 illustrates that a return value of “collectnodata” may be used as a conditional statement for the outcome component 1101. This return value may be used to generate a true or false value, or may itself be a true or false value. In some embodiments, the return value “collectnodata” may result in no data being returned to the outcome component 1101.

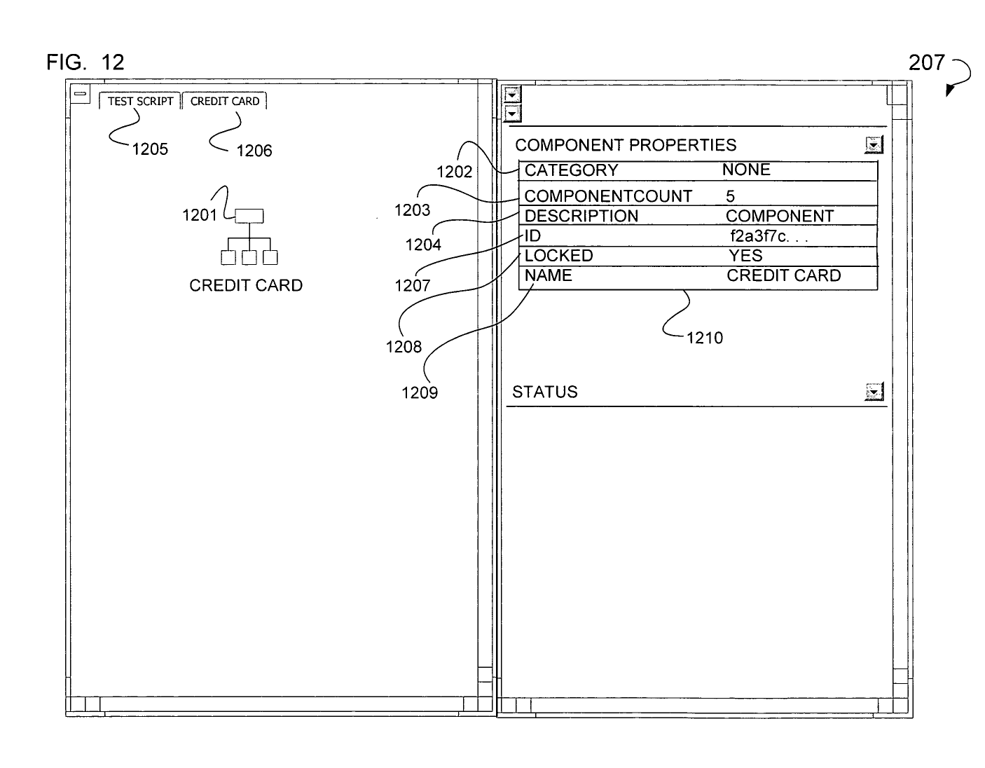

FIG. 12 is a diagram of an example script IDE 207 showing a function component 1201 and a description of this component. In some embodiments, a script generator 201 may be allowed to toggle or otherwise move between a function component, such as function component 1201, and test script underlying function component 1201. Tabs (e.g., 1205 and 1206) or other suitable screen objects or widgets may be used to toggle or otherwise move between the function component and the script underlying it. In this example, tab 1206 has been executed to reveal information relating to the function component 1201. Illustrated is a component properties window 1210 containing a number of fields 1202-1209. Field 1202 denotes the category or taxonomy to which the script underlying the function component 1201 belongs. Field 1203 illustrates the number of components (e.g., 5) that are used by this script underlying the function component 1201. Field 1204 illustrates what the component is that calls the script (e.g., a function component). Field 1207 shows a GUID for the function component 1201. Field 1208 provides a boolean value to be used to determine whether the script associated with the function component 1201 may be modified Here, this boolean value is set to “yes” (i.e., true). Field 1209 provides a proper name for the function component 1201, which in this example is “credit card”.

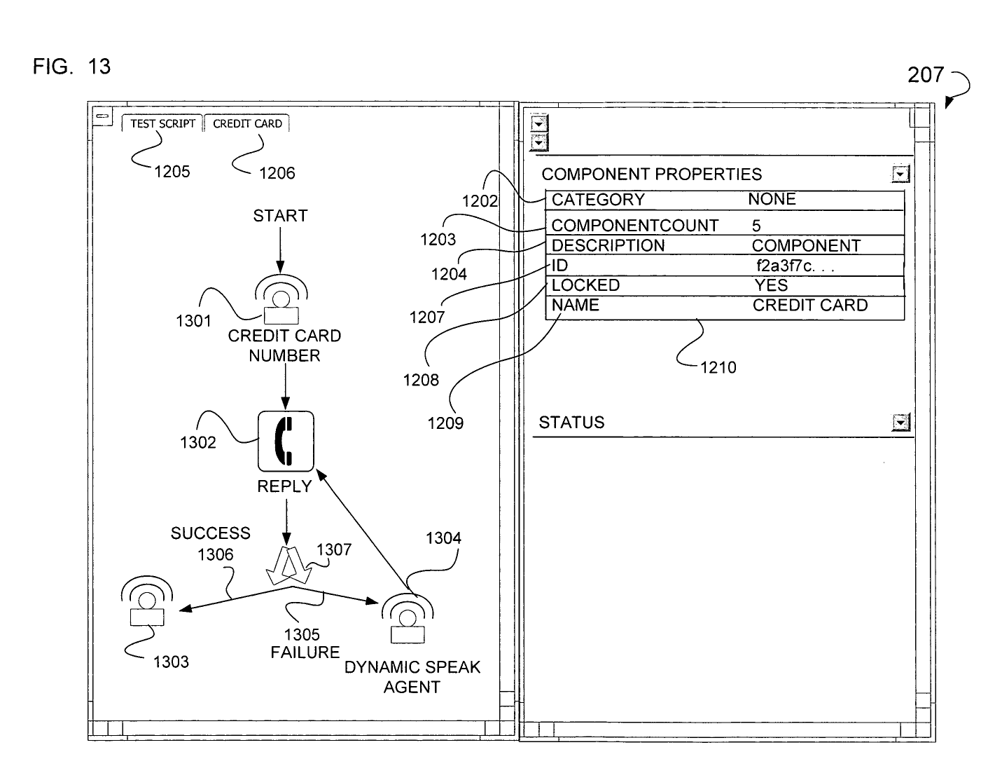

FIG. 13 is a diagram of an example script IDE 207 showing a function component 1201, the script underlying this component, and a description of this script and some of its associated components. Illustrated is the result of the execution of a tab 1205 showing the script associated with the function component 1201. Shown is a component 1301 in the form of a dynamic or variable speak component. A component 1302 is operatively associated with the component 1301 so as to collect or record information provided by, for example, a customer 115, in response to the execution of the component 1301. Next, a direct decisional component 1307 is executed wherein if, for example, the information provided by the customer 115 is “yes”, referenced herein as the success 1306 branch of the direct decisional component 1307, then a component 1303 may be executed. Component 1303 may be a dynamic or variable speak component. In cases where the direct decisional component 1307 evaluates to failure (e.g., referenced herein as the failure branch 1305; e.g., the customer 115 provides information amounting to “no”), a dynamic speak agent component 1304 is executed and the customer 115 may be re-prompted through the execution of the component 1302. After re-prompting, components 1302, 1307, and 1303 and 1304 may be re-executed.

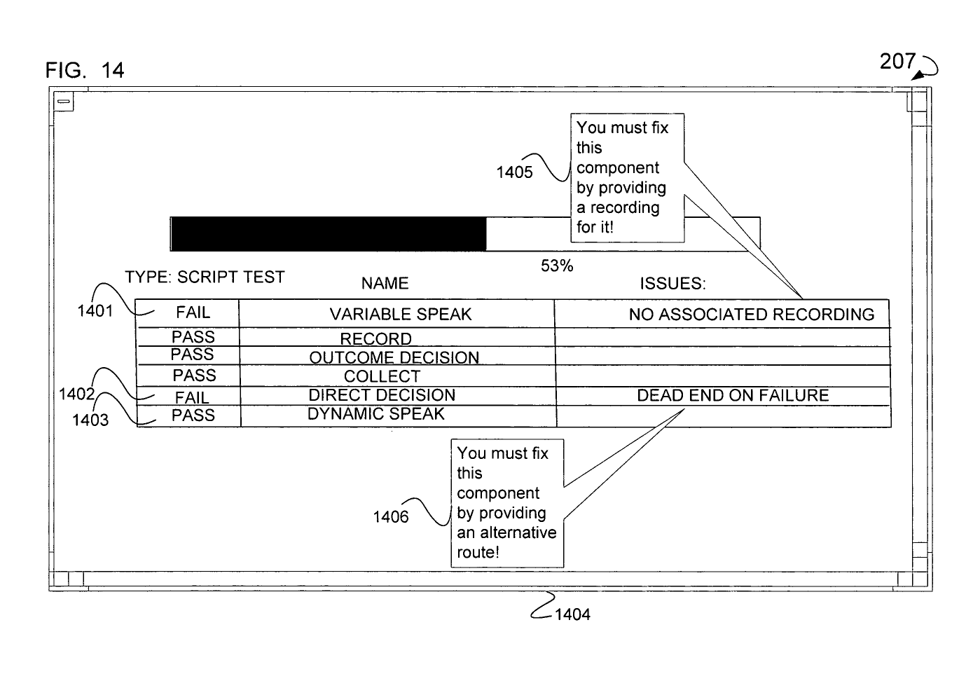

FIG. 14 is an example script IDE 207 showing the results of the execution of a script validator and/or tester. Illustrated is a script validator and/or tester showing the success of the testing of a script and its various components. Table 1404 shows whether various components that make up a script have tested successfully or have failed in their testing. The success or failure of a script may be based upon such factors as: attribute values associated with an individual component, whether or not these attribute values have been provided, whether or not they are required values returned by certain components relative to other components to which they are linked, and other suitable types of error detection. For example, field 1401 denotes the failure of a variable speak component where there is no associated recording with the variable speak component. In some cases, the variable speak component requires that an audio recording be associated with it, such that the audio recording is a required attribute of the variable speak component. In cases where there is no audio recording associated with the variable speak component, then a failure may occur.

An additional example of failure is illustrated in, for example, field 1402 where a direct decisional component has a branch that results in a script dead end. In some cases, the direct decisional component can be thought of as a conditional operation common to many logical systems, such that the conditional operation has a branch based upon a “true” condition and a branch based upon a “false” condition. In cases where one of these branches results in the cessation of the execution of a routine (e.g., a script), then this could be construed as a runtime failure or dead end. Similarly, here, where a direct decisional component results in a dead end, this is a runtime failure of the script that needs to be addressed prior to the implementation of the script on, for example, the previously-illustrated network appliance 107.

In some embodiments, pop-up windows 1405 and 1406 (collectively, message prompts) provide instructions to a script generator 201 in non-technical terms. In this example, pop-up window 1405 instructs the script generator 201 as to how the failure denoted in field 1401 may be fixed. Similarly, pop-up window 1406 instructs the script generator 201 as to how the failure outlined in field 1402 may be fixed. The messages appearing in these pop-up windows may be tailored to a specific type of error occurring from a particular component or script configuration. Further, these messages may be tailored for the skill level of the particular script generator 201 using the system and method illustrated herein.

Further illustrated is a field 1403 denoting the successful testing and/or validating of a dynamic speak component. Success of a component can be based upon whether certain attributes and conditions for attributes have been met, and also upon the relationship between a component and various other components at, for example, runtime. The logic for this validating and/or testing will be fully illustrated below.

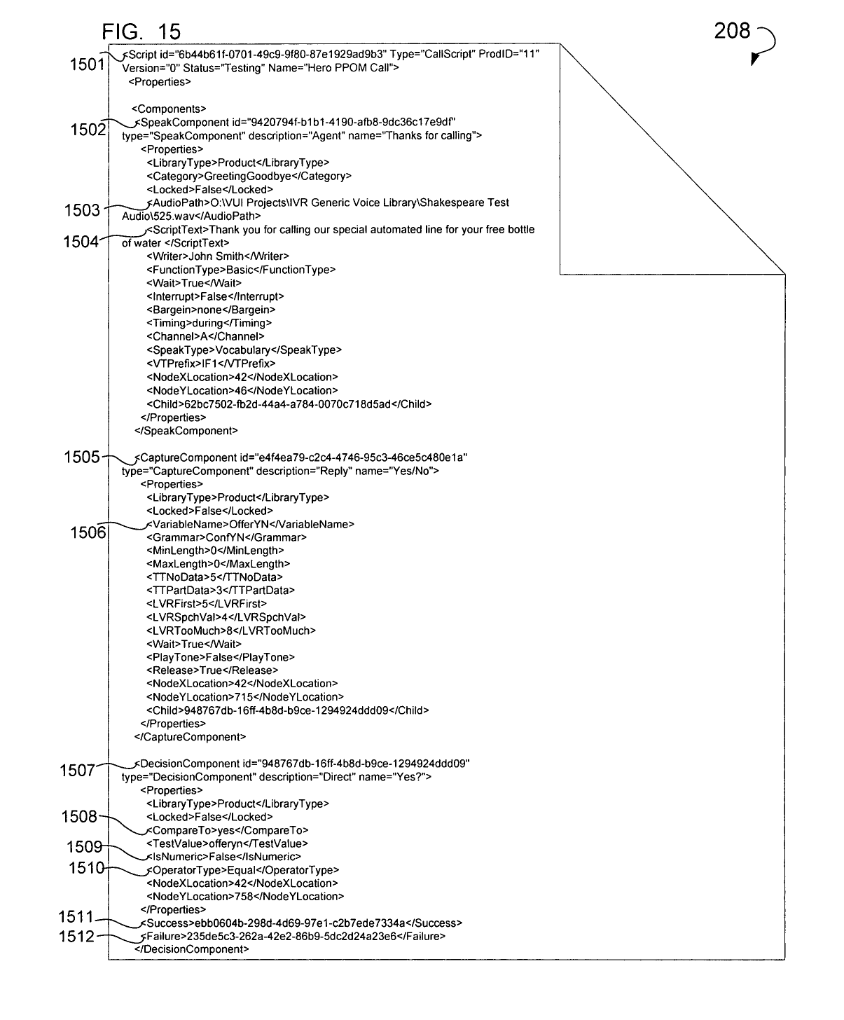

FIG. 15 is a diagram of an example IVR-XML script 208 illustrating an XML-based embodiment of a script and the components contained therein. Shown is a tag 1501 providing a GUID value for a script. Also denoted by this tag 1501 is the name of a particular script, which here, for example, is “Hero PPOM call”. This script contains a number of components. For example, tag 1502 denotes a speak component containing a GUID value and a description (which here is “agent”, and a name (which here is “thanks for calling”). Associated with this speak component is, for example, a tag 1503 that denotes the audio path or, more particularly, the file path location of the audio file for this speak component. Further, a tag 1504 denotes the text that may be associated with this audio file, such that this text, which here states “Thank you for calling our special automated line for your free bottle of water”, may be converted to speech using, for example, a text to speech conversion application. This text may, in some embodiments, serve as a default to the audio file referenced by tag 1503. An additional component associated with this script is denoted by tag 1505, illustrating a capture component. In some embodiments, the capture component may, for example, capture a “yes” or “no” decision of a particular caller, such as customer 115, in response to a query posed to them. Here, for example, as denoted by tag 1506, the customer 115 may be prompted with a request for a “yes” or “no” response. An additional component associated with this script is illustrated by tag 1507, wherein a decisional component is illustrated. This decisional component contains a GUID value, a type decision which here is decisional component, a further description as to whether it is a direct decisional component or outcome based decisional component, and a name, which here is “yes”. Additional tags illustrated with this decisional component include, for example, tag 1508 setting a value for the conditional statement for the decisional component, which here is set to “yes”; tag 1509 denoting whether numeric values may be used as a part of this conditional statement, which here is set to “false”; tag 1510 denoting the type of operator that may be used in the conditional value associated with the decisional component, which here is “equals”; tag 1511 denoting the identity of the next component to be executed should the conditional value evaluate to success (e.g., “true”); and tag 1512 denoting the identity of the component that should next be executed should the conditional value evaluate to failure (e.g., “false”). These ID values may be the previously-illustrated GUID values.

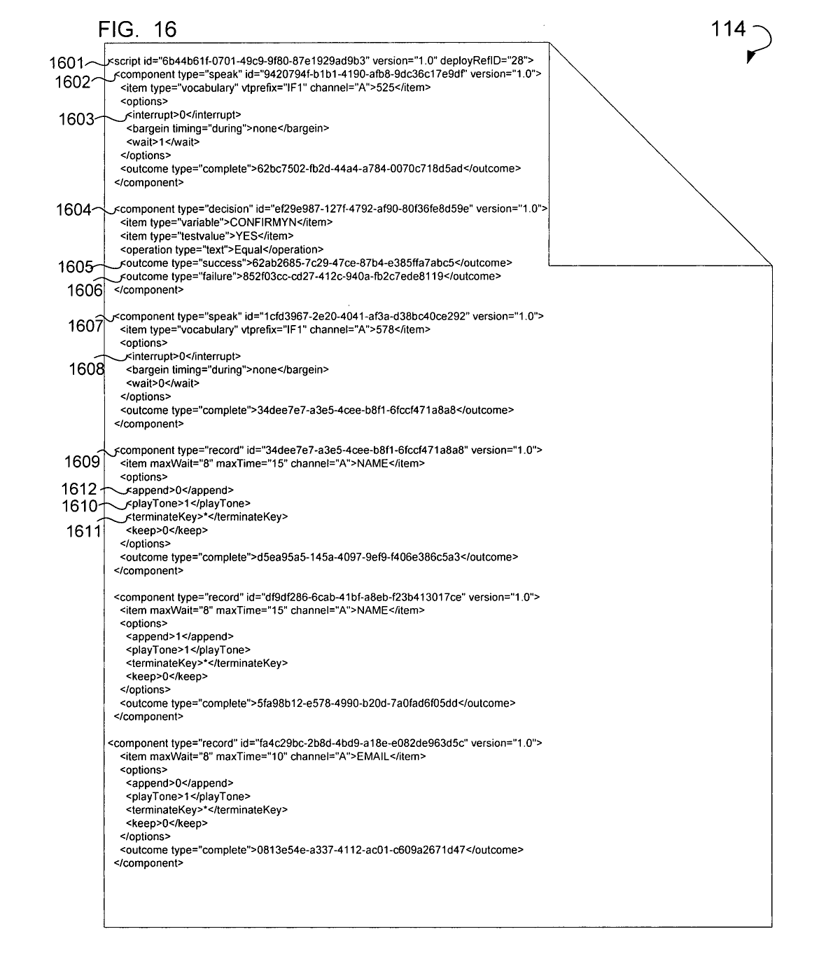

FIG. 16 is a diagram of an example training set 114 written in XML. As compared to, for example, the IVR-XML script 208, training set 114 is more linear in nature (e.g., a linear computer script). More to point, training set 114 is written such that the network appliance 107 that may process it may not have to utilize additional memory to store functions or other sub-routines that may have to be called for future use. Illustrated is a tag 1601 denoting the identity of a particular script. As with the IVR-XML script 208, the script contained within the training set 114 contains a number of components. For example, tag 1602 denotes a component type label as “speak”, wherein this speak component type allows for the recording of audio data generated by, for example, customer 115. Further, certain operations are provided such that, for example, tag 1603 denotes an interrupt operation whereby the customer 115 may press a zero button on a keypad to interrupt or stop their recording. The use of keys on a keypad to provide direction to an IVR system relies upon such concepts as DTMF, as previously illustrated. Further, tag 1604 illustrates a decisional component that may be, for example, an outcome decision. As part of this component, tag 1605 denotes the location of an additional component should the outcome be success, whereas tag 1606 denotes the location of an additional component should the outcome be failure. Success or failure for an outcome decisional component may be based upon a value returned from, for example, the network appliance 107 and input provided by the customer 115. Further, a tag 1607 is illustrated denoting a speak component. This speak component is similar to the speak component denoted by tag 1602 in that both contain interrupt tags (see e.g., tag 1603 and tag 1608). Further, a tag 1609 is illustrated denoting a captured component in the form of a record component. Associated with this record component are a number of functions denoted by additional tags. These may include, for example, tag 1610, which allows a customer, such as customer 115, to replay what they have recorded; tag 1611, which allows the customer to terminate the recording using, for example, the asterisk key; and tag 1612, which allows a customer 115 to append to the recording using, for example, the zero key.

### Example Logic

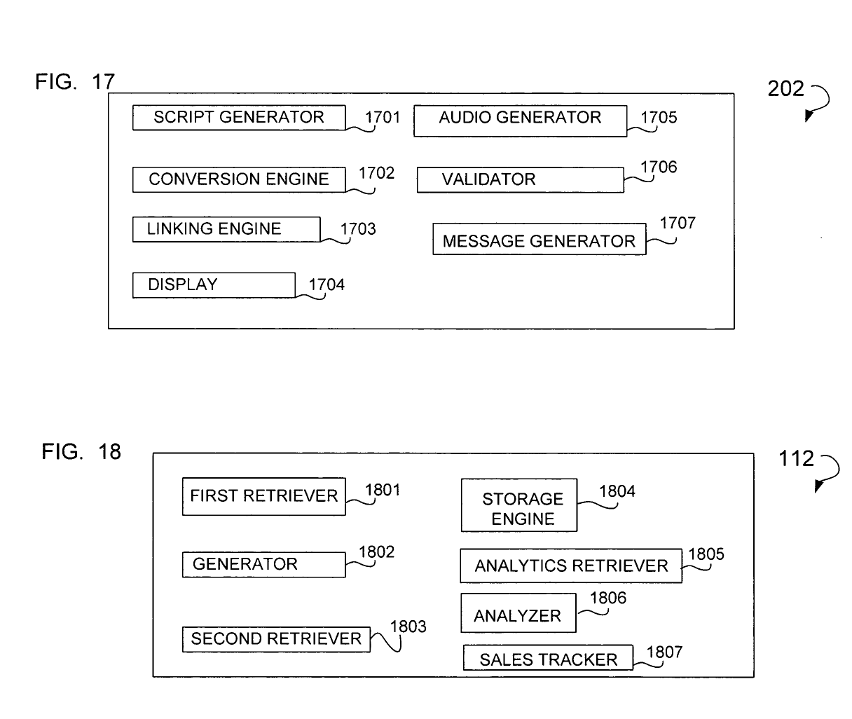

FIG. 17 is a block diagram of an example device 202 (e.g., the one or more devices 202) and the various blocks that may reside on this device. In some embodiments, these various blocks may be implemented in hardware, firmware, or even software. Device 202 includes a script generator 1701 to create a visual script containing a component that includes at least one of a function component, a decisional component, a speak component, and a capture component. Device 202 also includes a conversion engine 1702 to convert the visual script to a computer script. In some cases, the function component may contain at least one of a function component, a decisional component, a speak component, and a capture component. Further, in some cases the decisional component may allow for one of two components to be executed based upon a truth condition. Additionally, the speak component may play audio-based data for a caller, the audio based data including at least one of an audio recording and text that is converted to speech. Further, the capture component may capture data from a caller, the data including at least one of voice-based data and DTMF-based data. A linking engine 1703 is shown that facilitates linking of one of these components with another component contained in the visual script. A display 1704 is also shown that displays a component in a script IDE window. Display 1704 may also display a link relating the component to another component in a script IDE window. Moreover, display 1704 may display the visual script in a script IDE window. Further, the computer script may include at least one of a computer script written in IVR-XML and a computer script written as a character-delimited flat file. Additionally, an audio generator 1705 is illustrated that generates an audio file associated with the visual script. In some embodiments, device 202 may include a validator 1706 to validate a computer script that is formatted using at least one of an IVR-XML, or a character delimited flat file, and a message generator 1707 to generate a message prompt where an error is detected, the error including at least one of failing to meet a data definition criteria, a linking criteria, or a storage criteria (e.g., a criteria designating the storage format that a script is to be stored to). The message prompt may provide a text-based description describing how to fix the error such that the computer script will run to completion.

FIG. 18 is a block diagram of the script server 112 and the various blocks that may reside on this device. In some embodiments, these various blocks may be implemented in hardware, firmware, or even software. Illustrated is a script server 112 having a first retriever 1801 to retrieve a computer script from a pre-populated database, the computer script containing at least one component and being formatted using a language including at least one of an IVR-XML and a character-delimited flat file. Script server 112 also includes a generator 1802 to generate training data using the computer script, the training data formatted as a linear computer script. The pre-populated database may include at least one of a library status table, a voice talent table, a last index table, a scripts table, a components table, a category types table, and a categories table. Also, the script server 112 may include a second retriever 1803 to retrieve an audio file associated with the training data.

In some embodiments, the script server 112 may also include a generator 1802 to generate log information relating to a telephone call, the log information including a number called and a value representing thee duration of the telephone call, a second retriever 1803 to retrieve script information relating a computer script from a database, the script information including an identifier for the computer script, and an identifier for a component contained in the script, and a storage engine 1804 to store the log information and script information into OLAP database. Also, an analytics retriever 1805 may be employed to retrieve analytics from the OLAP database, the analytics including the log information and script information measured against time and date data. Further, an analyzer 1806 may be implemented to analyze the log information and script information for data including at least one of product percentage order conversion data, computer script driven versus non-computer script driven percentage sales, outcome type data, computer script success percentage, component success percentage, question order success percentage, question success percentage, and interactive drop off percentage. The outcome type data may include at least one of an order, a sale, and a lead. Further, the computer script success percentage may include at least one of a sale percentage generated using the computer script, a lead percentage using the computer script, and an order percentage using the computer script. In some cases, the component success percentage may include at least one of a sale percentage generated using the component, a lead percentage using the component script, an order percentage using the component script, and a inquiry percentage using the component script. Also shown is a sales tracker 1807 to track sales of an advertised product relative to the computer script. This sales tracker 1807 mat also track sales of an advertised product relative to the component. The identifier for the computer script may be a GUID value. The identifier for the component may be a GUID value.

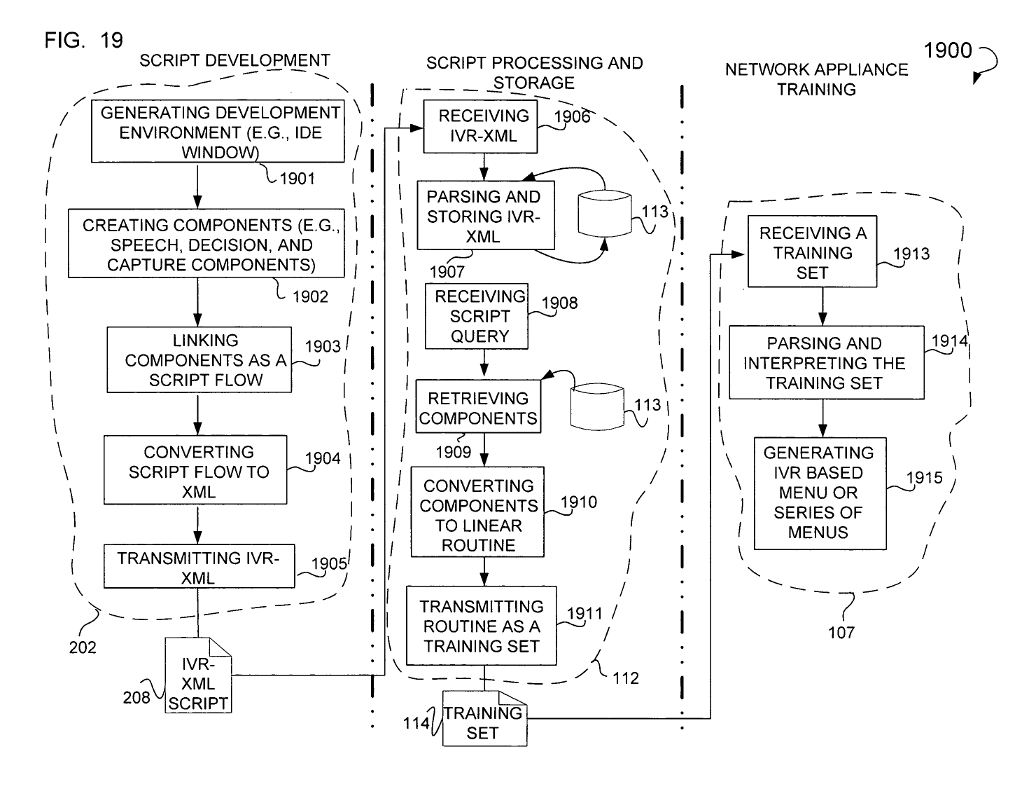

FIG. 19 is a tri-stream flowchart illustrating an example method 1900 to generate an IVR-XML script and to implement this IVR-XML script on, for example, a network appliance 107. Shown are a first stream titled “Script Development”, a second stream titled “Script Processing and Storage”, and a third stream titled “Network Appliance Training”. Starting with the first stream, an operation 1901 is executed to generate a development environment window (e.g., an IDE window). This environment window may be, for example, a script IDE 207. Once the development environment is generated, an operation 1902 is executed that creates components to populate this IDE window and to create associations between the components in the form of links. These components may be, for example, a speak component, a decisional component, and/or a capture component as previously illustrated. Once the components are created, an operation 1903 is executed wherein these components are linked into a script flow or a script. As previously illustrated in, for example, FIG. 5, a script may contain various components wherein each one of these components is associated via a link. As will be more fully described below, these links may exist in the form of associations between routines and sub-routines underlying the script and may seek to associate components by their GUID value. Once operation 1903 is executed, operation 1904 converts a script flow to an XML representation of the script flow. This process for converting a script to an XML representation will be more fully described below. Upon the execution of operation 1904, an operation 1905 is executed that transmits a completed IVR-XML script, such as IVR-XML script 208. Operations 1901-1905 may reside on, for example, one or more of the devices 202.

Once the IVR-XML script 208 is generated, at operation 1906, it may be received by, for example, a script server 112, where various operations exist on this script server 112. Once the IVR-XML script 208 has been received, an operation 1907 may be executed that parses the IVR-XML script 208 and stores it into, for example, a script database 113 for future use. In some embodiments, an operation 1908 is executed wherein a script query is received from, for example, the content server 110 and the content database 111 associated with it. Once the script query has been received, an operation 1909 is executed that retrieves the requested script and its associated components from, for example, the script database 113. An operation 1910 is then executed that converts the request script, and the components contained therein, in its IVR-XML script form to a linear routine. Next, an operation 1911 is executed that transmits this linear routine as a training set, such as training set 114. Training set 114 may be received through the execution of an operation 1913 that may reside on, for example, the network appliance 107. Once training set 114 has been received, an operation 1914 is executed that parses and interprets it. Then an operation 1915 may be executed that generates an IVR-based menu or series of menus based upon the parsed training set 114. Operations 1906, 1907, 1909, and 1910 may reside as a part of the script server 112. Further, operations 1913, 1914, and 1915 may reside as a part of, for example, the network appliance 107. Some of these various operations are described more fully below.

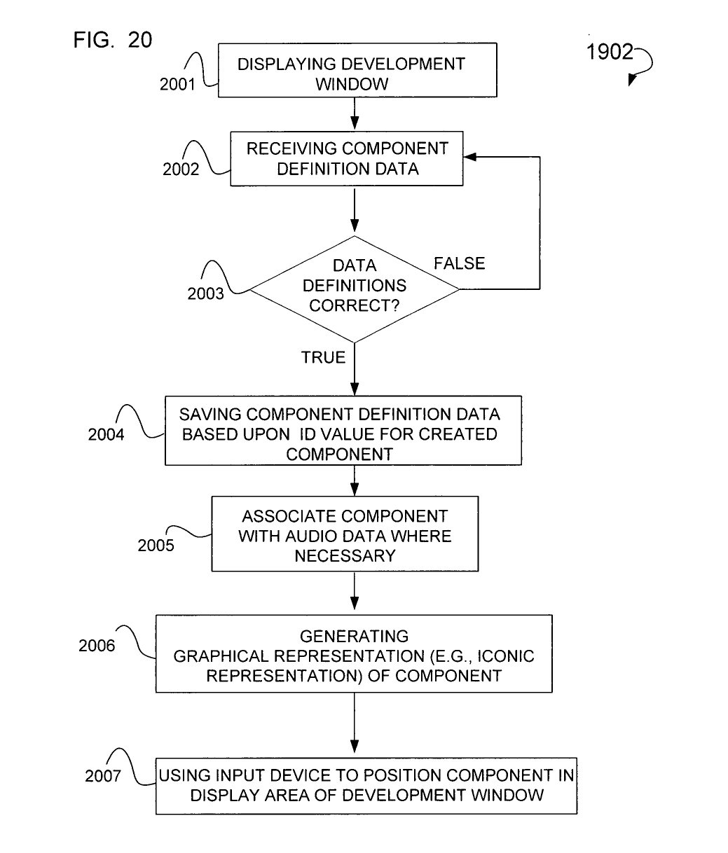

FIG. 20 is a flowchart illustrating an example method used to execute operation 1902. Illustrated is an operation 2001 that displays a development window such as script IDE 207 window. Once the window is displayed, an operation 2002 is executed that receives component definition data. This component definition data may be, for example, various data definitions assigned to, for example, a function component, a speak component, a decisional component, or a capture component. These data definitions may be numeric-based, logical-based (e.g., boolean), or may be some type of mathematical or logical operator (e.g., and, or, equals, less than, greater than, etc.). Next, a decisional operation 2003 is executed that determines whether or not the data definitions are correct. In cases where a decisional operation 2003 evaluates to “false” (e.g., one or more of the data definitions is incorrect), then operation 2002 is re-executed. In cases where a decisional operation 2003 evaluates to “true” (e.g., all of the data definitions are correct), an operation 2004 is executed. At operation 2004, a particular component's definition data is saved, based upon one of the previously alluded to ID values created for a component (e.g., a GUID value). Next, an operation 2005 is executed that associates a component with audio data where necessary. In some cases, certain components (e.g., a speak component such as variable speak) may have audio data associated with it. Such a scenario is reflected in FIG. 3. Once the audio data is associated with a particular component and/or generally a script, an operation 2006 is executed that generates graphical representations of the components. These graphical representations (as previously illustrated in, for example, FIGS. 5 through 13) may be icons representing, for example, a speak component, a decisional component, a capture component, or even a function component. Upon the successful generation of icons via the execution of operation 2006, an operation 2007 is executed wherein a script generator 201 may use an input device, such as a mouse, light pen, keyboard or other suitable input device, to position these various components (e.g., icons representing components) in the display area of a script IDE 207 window.

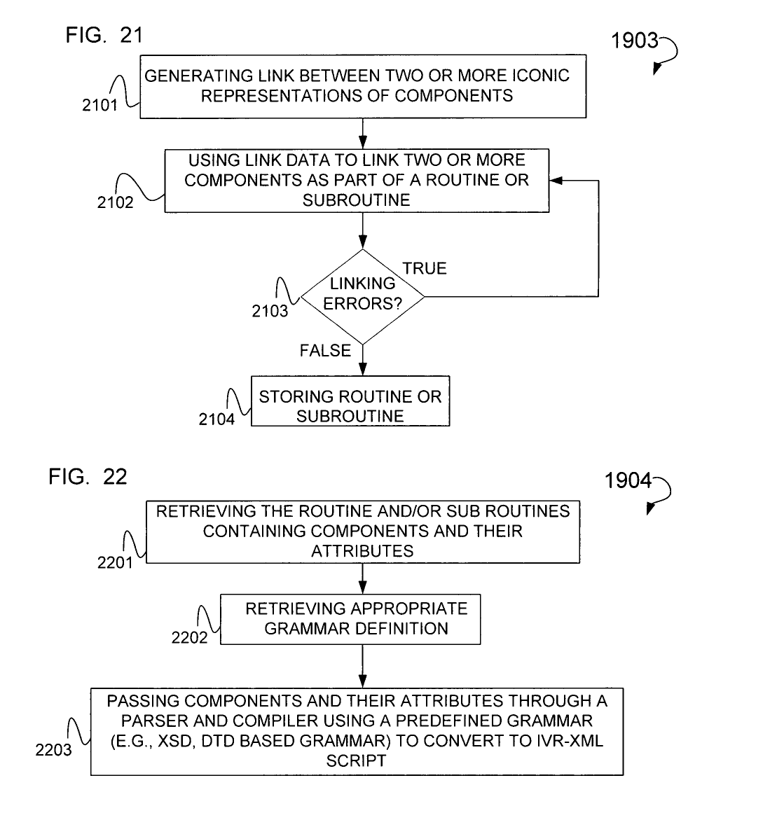

FIG. 21 is a flowchart illustrating an example method used to execute operation 1903. Illustrated is an operation 2101 that generates a link between two or more icon representations of components. As previously alluded to, in some cases, a script generator 201 may use an input device such as a mouse, light pen, and/or a keyboard to link two components that are displayed in a display area of a script IDE 207 window. Once components are linked, an operation 2102 is executed wherein linking data generated by the linking of two or more components are used to generate a routine or sub-routine. In certain cases, by generating a link displayed in an script IDE 207 window, corresponding routines or sub-routines are automatically generated, such that upon the successful execution of one component as represented by an icon, a subsequent component in the form of a routine or sub-routine will be executed. After two or more components are linked as part of a routine or sub-routine, a decisional operation 2103 is executed wherein linking errors are determined. A linking error may exist where a link is attempted to be established between or two or more components, but this link cannot in fact be established based upon certain attributes of one or more of the linked components. In cases where decisional operation 2103 evaluates to “true” (e.g., a linking error does exist), operation 2102 is re-executed and the script generator 201 is re-prompted to generate new links in lieu of the links containing errors. In cases where decisional operation 2103 evaluates to “false” (e.g., no linking errors exist), an operation 2104 is executed that stores a routine or sub-routine based upon the graphically-represented components and the links between these components.

FIG. 22 is a flowchart illustrating an example method used to execute operation 1904. Illustrated is an operation 2201 that retrieves a routine and/or sub-routine corresponding to a component, the attributes of a component, and the links between these components. Next, an operation 2202 is executed that retrieves the appropriate grammar definition for a routine or sub-routine. This grammar definition will dictate how this routine or sub-routine may be parsed. Next, an operation 2203 is executed that parses a component's attributes and links through a parser and compiler using the retrieved grammar to convert this routine/sub-routine and their attributes and links to, for example, an IVR-XML script. This grammar may be, for example, an XSD- or DTD-based grammar.

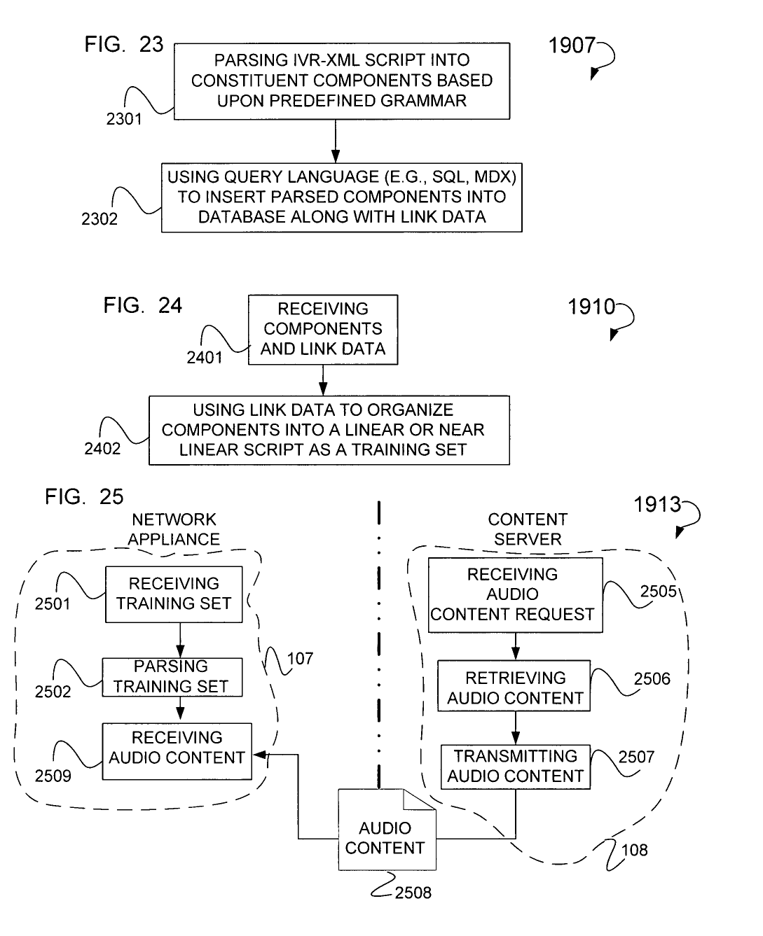

FIG. 23 is a flowchart illustrating an example method used to execute operation 1907. Illustrated is an operation 2301 that parses an IVR-XML script into its constituent components based upon some predefined grammar. Next, an operation 2302 is executed that uses a query language such as, for example, an SQL or an MDX-based query language to insert the parsed components into a database along with their link data.

FIG. 24 is a flowchart illustrating an example method used to execute operation 1910. Illustrated is an operation 2401 that receives components and link data. Once the components and link data have been received, an operation 2402 is executed that uses the link data to organize components into a linear or near-linear script as a training set 114. As previously alluded to, this linear script may be processed or executed by, for example, the network appliance 107 in a linear fashion, such that little or none of the script needs to be stored prior to or during execution of the script.

FIG. 25 is a dual-stream flowchart illustrating an example method used to execute operation 1913 Illustrated are a first stream titled “network appliance” and a second stream titled “content server”. With regard to the first stream, various operations associated with the stream may reside as part of, for example, the network appliance 107. With regard to the second stream, the various operations shown in the stream may reside as a part of, for example, the content server 108. Illustrated is an operation 2501 that receives a training set such as training set 114. Once the training set is received, an operation 2502 is executed that parses the training set. Through the execution of an operation 2505, an audio content request (not pictured) is received based upon the execution of an IVR-XML script 301, or even, in some cases, the training set 114. Once this audio content request is received, an operation 2506 may retrieve actual audio content from, for example, a content database such as content database 109. Once retrieved, the audio content is transmitted through the execution of an operation 2507 wherein this audio content is now audio content 2508. Once the audio content is retrieved and transmitted, an operation 2509 residing as part of the network compliance 107 may receive audio content 2508 to be used in the generation of the IVR.

FIG. 26 is a flowchart illustrating an example method 2600 used to store a record of a call, such as call 105. Method 2600 may reside on or be executed by, for example, the script server 112 or some other suitable server such as a database server. Shown is a call 105 that is received through the execution of an operation 2601. Once operation 2601 is executed, an operation 2602 is executed that logs the call information, or creates a log of the call. This call information may include, for example, the number called or used to make the call (e.g., the callee's number), the duration of the call, and other suitable information. Next, an operation 2603 is executed that retrieves information for the script that facilitated the call from the previously illustrated script database 113. This information may include the GUID for the script and the components contained in the script. Then, an operation 2604 is executed that stored the call information and script information into a call log database 2605. Additionally, this database may also store data relating to the outcome of the call 105, such as whether the call resulted in an order for an advertised good or service, a sale, or even a sales lead. In some embodiments, this outcome data is stored and retrieved from some other database not pictured herein. Call log database 2605, in some cases, may be an RDS-based database that utilizes SQL to insert and select data. Further, periodically an operation 2606 may be executed that in effect extracts data from the call log database 2605, transfers it to an OLAP format, and loads it into an OLAP-based database 2607. In some embodiments, a plurality of OLAP-based databases may be implemented. Through using OLAP-based database 2607, the outcome data may be understood and analyzed in terms of certain time criteria.

FIG. 27 is a flowchart illustrating an example method 2700 showing analysis of the data contained in the OLAP-based database 2607. Method 2700 may reside on or be executed by the script server 112, or some other suitable sever such as a database server. Illustrated is an analytics instruction set 2701 that is received through the execution of an operation 2702. Next, an operation 2703 is executed that parses the analytics instruction set 2701 and converts it to an MDX query. In some embodiments, the analytics instruction set itself contains an MDX query, obviating the need for execution of the operation 2703. Then an operation 2704 may be executed that retrieves and displays these analytics. Using MDX, or even in some cases, a Data Mining Extensions (DMX) language an analysis can be performed including, generating a breakdown of order conversion, a breakdown of orders that are generated based upon a particular script (e.g., IVR-XML script 208), a breakdown of order, sales, lead, or inquiry by script or script component, or some other suitable analysis. This analysis may relate to good and services.

### Example Database

Some embodiments may include the various databases (e.g., 109, 111, 113, and 2607) being relational databases, or in some cases OLAP-based databases. In the case of relational databases, various tables of data are created and data is inserted into and/or selected from these tables using SQL or some other database-query language known in the art. In the case of OLAP databases, one or more multi-dimensional cubes or hypercubes containing multidimensional data may be implemented, which data may be selected from or inserted into using MDX. In the case of a database using tables and SQL, a database application such as, for example, MYSQL™, SQLSERVER™, Oracle 8I™, 10G™, or some other suitable database application may be used to manage the data. In the case of a database using cubes and MDX, a database using Multidimensional On Line Analytic Processing (MOLAP), Relational On Line Analytic Processing (ROLAP), Hybrid Online Analytic Processing (HOLAP), or some other suitable database application may be used to manage the data. These tables, or cubes made up of tables in the case of, for example, ROLAP, are organized into an RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization or optimization algorithm known in the art.

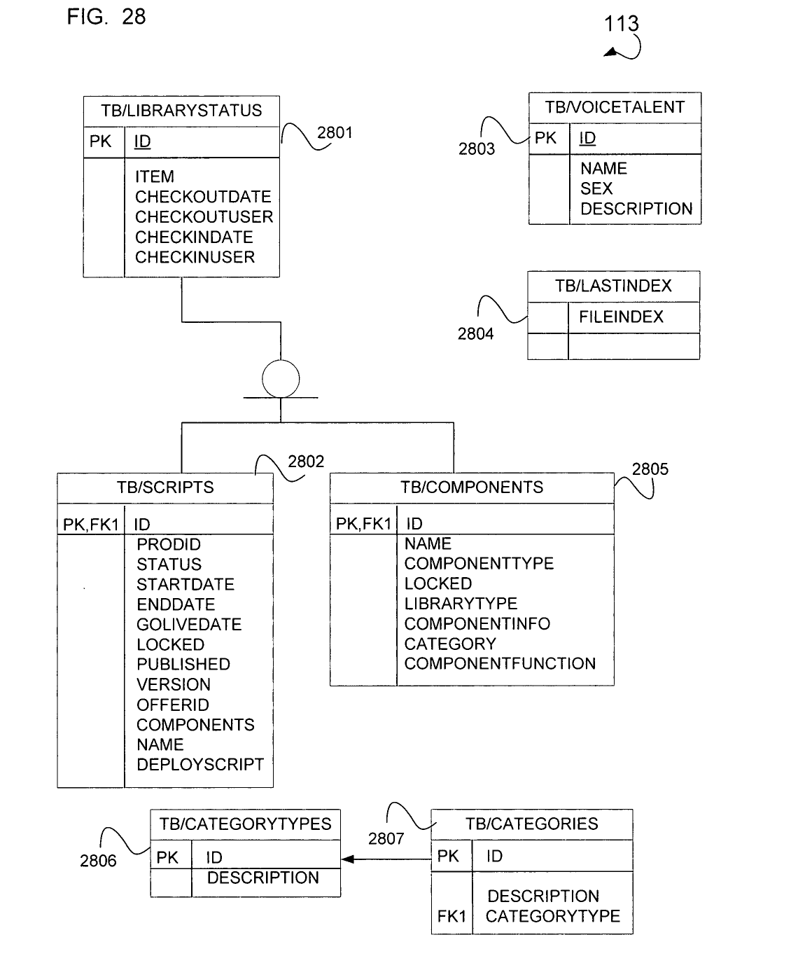

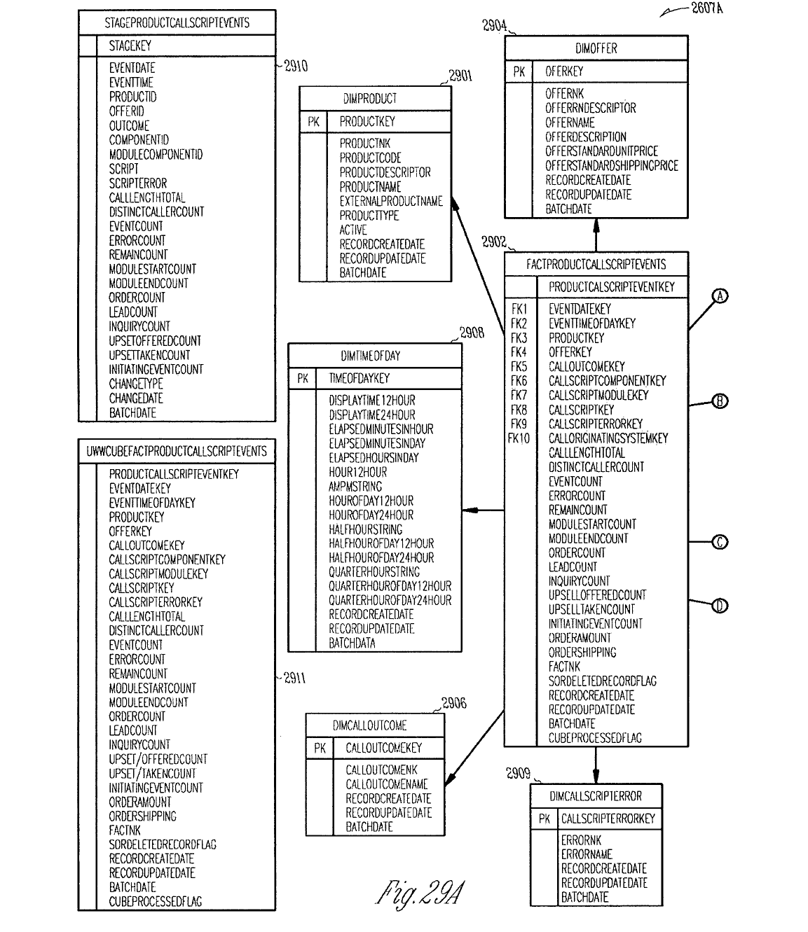

FIG. 28 is an example RDS that may reside as a part of, for example, the script database 113. Shown are various database tables containing a number of data identifier types. For example, a library status table 2801 contains data identifier types of item, checkout date, checkout user, check-in date, and check-in user. These various data identifier types may be gleaned from, for example, the IVR-XML script 208 or 301 as, for example, data denoted by various tagging values (e.g., 1503-1506). Further, a scripts table 2802 is shown containing a product ID value, a status value, a start date, an end date, a go-live date, a locked value, a published value, a version value, an author ID value, a component value, a name value, and a deploy script value. Next, a voice talent table 2803 is provided that contains data identifiers including, for example, a name value, a sex value, and a description value. Further, a last index table 2804 is shown that contains a file index value. A components table 2805 is illustrated that contains data identifiers including, for example, the name of a component, a component type, a locked value, a library type, a component info value, a category value, and a component function value. A table 2806 is illustrated titled “Category Types” and containing a data identifier in the form of a description. Further, a categories table 2807 is shown containing data identifiers including a description identifier and a category type identifier. In some embodiments, the various data identifiers described herein may be of an XML data type, such that individual XML tags are parsed out of, for example, the IVR-XML script and placed into their respective tables. In this way, an item tag may be placed in, for example, the library status table 2801 as may, for example, a checkout user tag or a check-in date tag or a check-in user tag. In other embodiments, in lieu of parsing the IVR-XML script and placing the respective XML tags into one or more of the tables (e.g., 2801-2807), the specific data associated with the individual tags may be parsed and placed into the tables. For example, rather than placing the tag and its associated data into the components table 2805 under the data identifier type name, only the name of the specific component may be placed into this identifier value without its associated XML tag. In cases where the data is taken from the XML tag and stored directly into a table, additional data types may be used, such as, for example, a string data type in the case of the name data identifier contained in the components table 2805, or a date data type in the case of the library status table 2801 and its check-in date data identifier type, or a boolean data type in the case of the components table 2805 and the locked data identifier type. The decision to store XML tags and their associated data, rather than only the data associated with the XML tag, may be left to a particular developer's implementation needs and desires.

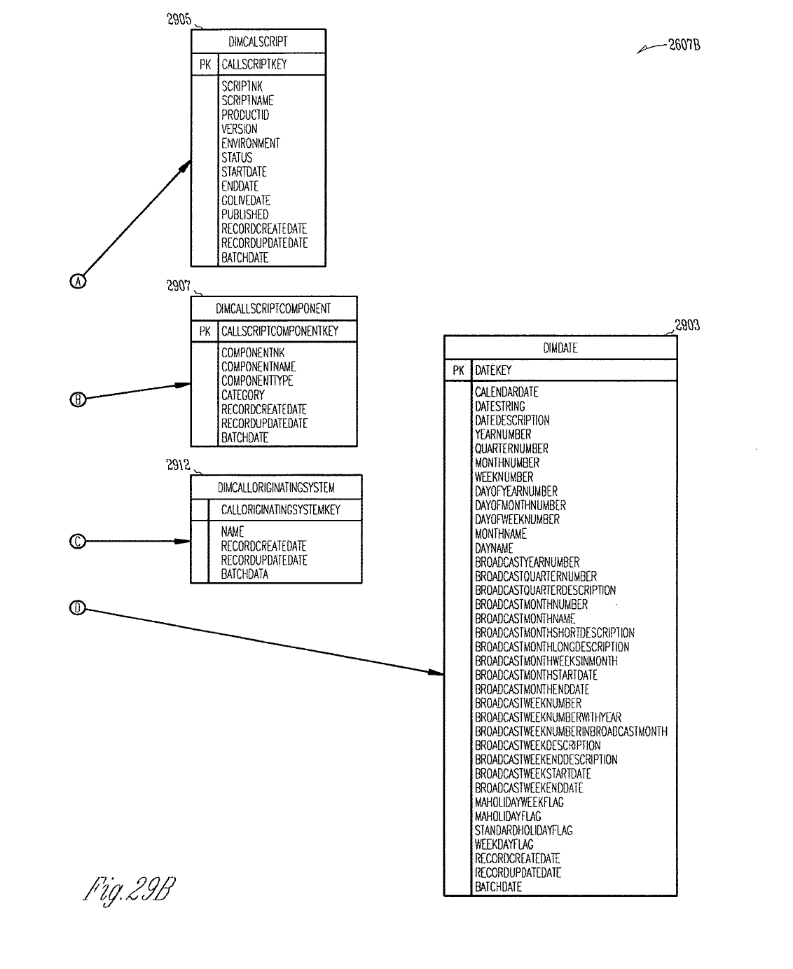

FIG. 29 is an example schema that may reside as a part of the OLAP-based database 2607. As a threshold matter, contained in some of the tables illustrated below is a Natural Key (NK) value that roughly corresponds to the GUID value used to track the script and related components in the script database 113. Illustrated is a DimProduct table 2901 that contains various fields relating to an advertiser's products being advertised via, for example, an IVR-XML script such as IVR-XML script 208 or 301. In some embodiments, the various fields in the DimProduct table 2901 may have a data type of string, Character Large Object (CLOB), or other suitable data type. Further, illustrated is a FactProductCallScriptEvents table 2902 that tracks the various responses by caller such as customer 115. These responses may include, for example, the offer that was made to the caller and the response thereto, the script presented to the caller and the response thereto, whether a purchase was made based upon the offer, and a variety of other suitable information. Data types used in this FactProductCallScriptEvents table 2902 may include integers, strings, and other suitable data types. Also shown is a DimDate table 2903 containing data and time information that, in effect, allows for the data contained in the OLAP multidimensional cube to be analyzed based upon time and date dimensions. Some of the example data types used in this DimDate table 2903 include a date data type, a boolean data type, and a variety of other suitable data types. In some embodiments, a DimOffer table 2904 allows for the analysis to be conducted across offers (e.g., across multiple advertisements each attempting to sell a good or service) to determine the relative effectiveness of each. DimOffer table 2904 may contain data types including strings, integers, or other suitable data types. Some embodiments may include a DimCallScript table 2905 that contains information relating to a particular script and the components used therein. This information may include the length of time the script actually ran, and other suitable information. Data types used within this DimCallScript table 2905 include an integer, date, and other suitable data types. Also illustrated is a DimCallOutcome table 2906 that contains information showing the outcome of a call, namely whether or not the call resulted in an order, lead, or sale. A string data type may be used for the fields in this table. A DimCallScriptComponent table 2907 is illustrated that allows for the tracking of specific components in a script, and the relation between a component and a script (e.g., whether the script is a parent of the script, as is the case with a script that contains a component type component). A string data type and/or an integer data type may be used. Another type of table is a DimTimeofDay table 2908 that tracks the time of day during which a call occurred. Through the use of this table, the success of a script and/or components contained therein may be tracked relative to a time of day. Time and date data types may be used in this table. Another table illustrated herein is a DimCallScriptError table 2909 that tracks errors in a particular script. This table may use a string data type to track the name of the error encountered in the script. A further StageProductCallScriptEvents table 2910 is shown that contains data relating to, for example, an offer and the success of that offer in generating sale. Among the other data fields contained in this table 2910 is a field relating to upselling of an offer. This various data types that may be utilized in this table include integers, date, string, or some other suitable data type. Also shown is uvwCubeFactProductCallScriptEvents table 2911 that may in some cases contain various fields relating to the aggregation of the one or more multidimensional cubes that may be implemented in one embodiment of the system and method illustrated herein. Data types utilized in this table may include, a string, integer, boolean, or other suitable data type.

In some embodiments, a query language such as MDX or DMX is utilized to query the OLAP database 2607. Queries made of the OLAP database 2607 may include determining product percentage order conversion data, the number of computer script driven versus non-computer script driven percentage sales, outcome type data, a computer script success percentage, a component success percentage, a question order success percentage, a question success percentage, or interactive drop off percentage. For example, product percentage order conversion data may be generated through querying the StageProductCallScriptEvents table 2910 in combination with the DimTimeofDay table 2908, and/or some other suitable table. Next, the number of computer script driven versus non-computer script driven percentage sales may be determined through using the DimProduct table 2901, the DimCallScript table 2905, and/or some other suitable table. Further, the outcome type data may be generated through using the DimCallOutcome table 2906 in combination with, for example, the DimTimeofDay table 2908, and/or some other suitable table. Additionally, the computer script success percentage may be generated through accessing the FactProductCallScriptEvents table 2902, the StageProductCallScriptEvents table 2910, and/or some other suitable table. Further, the DimCallScriptComponent table 2907 may be used to determine a component success percentage when used in combination with some other suitable table. A question order success percentage may be determined through querying a DimCallScript table 2905 in addition to some other suitable table. Also, a question success percentage may be able to be determined through querying a DimCallOutcome table 2906 in combination with, for example, a DimOffer table 2904 or some other suitable table. Moreover, an interactive drop off percentage may be determined through querying the StageProductCallScriptEvents table 2910.

### A Three-Tier Architecture

In some embodiments, a method is described as implemented in a distributed or non-distributed software application designed under a three-tier architecture paradigm, whereby the various components of computer code that implement this method may be categorized as belonging to one or more of these three tiers. Some embodiments may include a first tier as an interface (e.g., an interface tier) that is relatively free of application processing. Further, a second tier may be a logic tier that performs application processing in the form of logical/mathematical manipulations of data inputted through the interface level, and communicates the results of these logical/mathematical manipulations to the interface tier and/or to a backend, or storage, tier. These logical/mathematical manipulations may relate to certain business rules, or processes that govern the software application as a whole. A third, storage tier, may be a persistent or non-persistent storage medium. In some cases, one or more of these tiers may be collapsed into another, resulting in a two-tier or even a one-tier architecture. For example, the interface and logic tiers may be consolidated, or the logic and storage tiers may be consolidated, as in the case of a software application with an embedded database. This three-tier architecture may be implemented using one technology, or, as will be discussed below, a variety of technologies. This three-tier architecture, and the technologies through which it is implemented, may be executed on two or more computer systems organized in a server-client, peer to peer, or some other suitable configuration. Further, these three tiers may be distributed between more than one computer system as various software components.

### Component Design

Some example embodiments may include the above described tiers, and processes or operations that make them up, as being written as one or more software components. Common to many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component oriented, or object-oriented programming technique can be implemented using a Visual Component Library (VCL), Component Library for Cross Platform (CLX), Java Beans (JB), Enterprise Java Beans (EJB), Component Object Model (COM), Distributed Component Object Model (DCOM), or other suitable technique. These components may be linked to other components via various Application Programming interfaces (APIs), and then compiled into one complete server, client, and/or peer software application. Further, these APIs may be able to communicate through various distributed programming protocols as distributed computing components.

### Distributed Computing Components and Protocols

Some example embodiments may include remote procedure calls being used to implement one or more of the above described components across a distributed programming environment as distributed computing components. For example, an interface component (e.g., an interface tier) may reside on a first computer system that is located remotely from a second computer system containing a logic component (e.g., a logic tier). These first and second computer systems may be configured in a server-client, peer-to-peer, or some other suitable configuration. These various components may be written using the above-described object-oriented programming techniques, and can be written in the same programming language or in different programming languages. Various protocols may be implemented to enable these various components to communicate regardless of the programming language(s) used to write them. For example, a component written in C++ may be able to communicate with another component written in the Java programming language through use of a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model or the Transmission Control Protocol/Internet Protocol (TCP/IP) protocol stack model for defining the protocols used by a network to transmit data.

### A System of Transmission Between a Server and Client

Some embodiments may utilize the OSI model or TCP/IP protocol stack model for defining the protocols used by a network to transmit data. In applying these models, a system of data transmission between a server and client, or between peer computer systems, is described as a series of roughly five layers comprising: an application layer, a transport layer, a network layer, a data link layer, and a physical layer. In the case of software having a three tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. The TCP segment is loaded into the data load field of an IP datagram residing at the network layer. Next, the IP datagram is loaded into a frame residing at the data link layer. The frame is then encoded at the physical layer, and the data is transmitted over a network such as an internet, Local Area Network (LAN), Wide Area Network (WAN), or some other suitable network. In some cases, the term internet refers to a network of networks. These networks may use a variety of protocols for the exchange of data, including the aforementioned TCP/IP as well as ATM, SNA, SDI, or some other suitable protocol. These networks may be organized within a variety of topologies (e.g., a star topology) or structures.

### Example Computer System

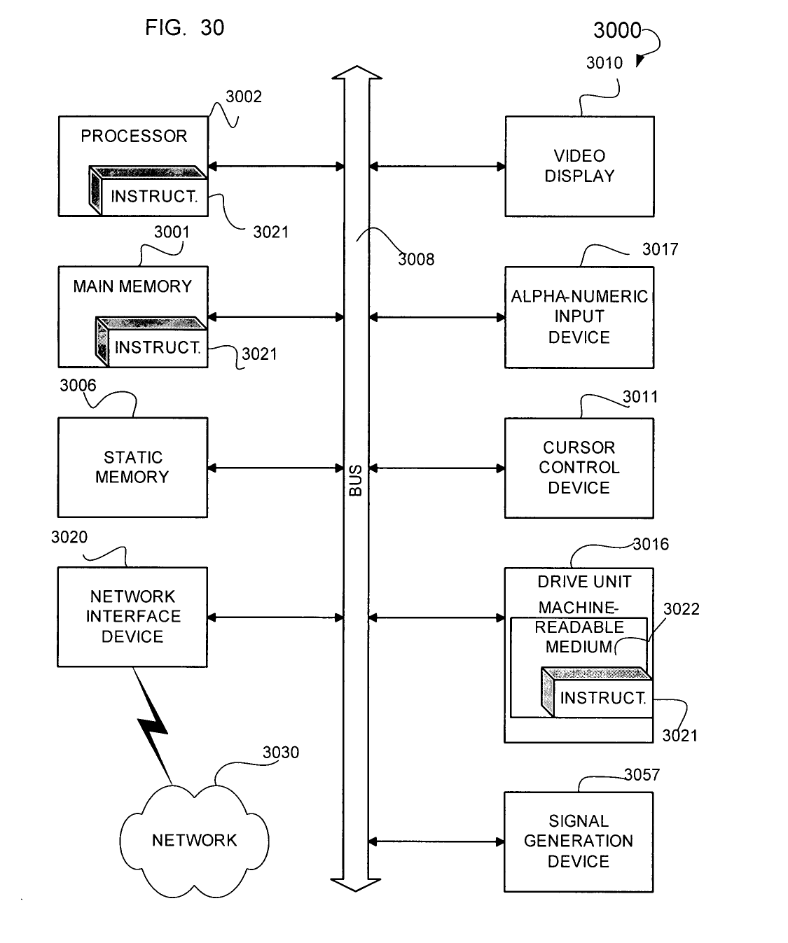

FIG. 30 shows a diagrammatic representation of a machine in the example form of a computer system 3000 that executes a set of instructions for causing the machine to perform any one or more of the methodologies discussed herein. In alternative embodiments, the machine may operate as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a Personal Computer (PC), a tablet PC, a Set-Top Box (STB), a PDA, a cellular telephone, a web appliance, a network router, IVR switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems that are linked (e.g., either by hardwired, wireless, or a combination of hardwired and wireless connections) through a network both perform tasks such as those illustrated in the above description.

The example computer system 3000 includes a processor 3002 (e.g., a Central Processing Unit (CPU), a Graphics Processing Unit (GPU) or both), a main memory 3001 and a static memory 3006, which communicate with each other via a bus 3008. The computer system 3000 may further include a video display unit 3010 (e.g., a Liquid Crystal Display (LCD) or a Cathode Ray Tube (CRT)). The computer system 3000 also includes an alphanumeric input device 3017 (e.g., a keyboard), a User Interface (UI) cursor controller device 3011 (e.g., a mouse), a drive unit 3016, a signal generation device 3057 (e.g., a speaker) and a network interface device (e.g., a transmitter) 3020.

The disk drive unit 3016 includes a machine-readable medium 3022 on which is stored one or more sets of instructions 3021 and data structures (e.g., software) embodying or utilized by any one or more of the methodologies or functions illustrated herein. The software 3021 (e.g., instruct, 3021) may also reside completely or at least partially within the main memory 3001 and/or within the processor 3002 during execution thereof by the computer system 3000, the main memory 3001 and the processor 3002 also constituting machine-readable media.

The instructions 3021 may further be transmitted or received over a network 3030 via the network interface device 3020 utilizing any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that stores the one or more sets of instructions. The term “machine-readable medium” shall also be taken to include any medium that is capable of storing, encoding or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic media, and carrier wave signals.

### Marketplace Applications

IVR systems and methods allows for consumers of goods and services to be served with limited human interaction. This said, there is still a need for the IVR systems and methods to be effective marketing tools. The ability of an IVR system and method to be an effective marketing tool is based in large part on the interface that it provides to a consumer, and, more to the point, on the marketing content developed for such interfaces by individuals such as marketing or copywriting professionals. Historically, the reliance of these individuals on others such as software developers to generate IVR scripts has limited the effectiveness of these interfaces, for the effectiveness of the IVR scripts was contingent upon the abilities of the software developers rather than the abilities of the marketing or copywriting professionals. In some embodiments, by allowing individuals such as marketing or copywriting professionals to directly develop and implement IVR scripts, the IVR system and method illustrated herein allows for IVR scripts that more clearly reflect the goals of these individuals.

It is to be understood that the above description is intended to be illustrative and not restrictive. Although numerous characteristics and advantages of various embodiments as illustrated herein have been set forth in the foregoing description, together with details of the structure and function of various embodiments, many other embodiments and changes to details may be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels and are not intended to impose numerical requirements on their objects.

The Abstract of the Disclosure is provided to comply with 37 C.F.R. §1.72(b), requiring an abstract that may allow the reader to quickly ascertain the nature of the technical disclosure. It is submitted with the understanding that it may not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
creating a visual script containing a component that includes at least one of a function component, a decisional component, a speak component, and a capture component; and
converting the visual script to a computer script.

2. The method of claim 1, wherein the function component contains at least one of a function component, a decisional component, a speak component, and a capture component.

3. The method of claim 1, wherein the decisional component allows for one of two components to be executed based upon a truth condition.

4. The method of claim 1, wherein the speak component plays audio-based data for a caller, the audio-based data including at least one of an audio recording and text that is converted to speech.

5. The method of claim 1, wherein the capture component captures data from a caller, the data including at least one of voice-based data and Dual Tone Multi-Frequency (DTMF) based data.

6. The method of claim 1, further comprising linking the component with another component contained in the visual script.

7. The method of claim 1, further comprising displaying the component in a script Integrated Development Environment (IDE) window.

8. The method of claim 1, further comprising displaying a link relating the component to another component in a script Integrated Development Environment (IDE) window.

9. The method of claim 1, further comprising displaying the visual script in a script Integrated Development Environment (IDE) window.

10. The method of claim 1, wherein the computer script includes at least one of a computer script written in an Interactive Voice Response-eXtensible Markup Language (IVR-XML), and a computer script written as a character-delimited flat file.

11. The method of claim 1, further comprising generating an audio file associated with the visual script.

12. A method comprising:
retrieving a computer script from a pre-populated database, the computer script containing at least one component, the computer script formatted using a language including at least one of an Interactive Voice Response-eXtensible Markup Language (IVR-XML) and a character-delimited flat file; and
generating training data using the computer script, the training data formatted as a linear computer script.

13. The method of claim 12, wherein the pre-populated database includes at least one of a library status table, a voice talent table, a last index table, a scripts table, a components table, a category types table, and a categories table.

14. The method of claim 12, further comprising retrieving an audio file associated with the training data.

15. A method comprising:
passing a computer script through a script validator, the computer script formatted using at least one of an Interactive Voice Response-eXtensible Markup Language (IVR-XML) and a character-delimited flat file; and
generating a message prompt where an error is detected, the error including at least one of a data definition criteria, a linking criteria, and a storage criteria.

16. The method of claim 15, wherein the message prompt provides a text-based description describing how to fix the error so as to allow the computer script to run to completion.

17. A computer system comprising:
a script generator to create a visual script containing a component that includes at least one of a function component, a decisional component, a speak component, and a capture component; and
a conversion engine to convert the visual script to a computer script.

18. The computer system of claim 17, wherein the function component contains at least one of a function component, a decisional component, a speak component, and a capture component.

19. The computer system of claim 17, wherein the decisional component allows for one of two components to be executed based upon a truth condition.

20. The computer system of claim 17, wherein the speak component plays audio-based data for a caller, the audio-based data including at least one of an audio recording and text that is converted to speech.

21. The computer system of claim 17, wherein the capture component captures data from a caller, the data including at least one of voice-based data and Dual Tone Multi-Frequency (DTMF) based data.

22. The computer system of claim 17, further comprising a linking engine to link the component with another component contained in the visual script.

23. The computer system of claim 17, further comprising a display to display the component in a script Integrated Development Environment (IDE) window.

24. The computer system of claim 17, further comprising a display to display a link relating the component to another component in a script Integrated Development Environment (IDE) window.

25. The computer system of claim 17, further comprising a display to display the visual script in a script Integrated Development Environment (IDE) window.

26. The computer system of claim 17, wherein the computer script includes at least one of a computer script written in an Interactive Voice Response-eXtensible Markup Language (IVR-XML) and a computer script written as a character delimited flat file.

27. The computer system of claim 17, further comprising an audio generator to generate an audio file associated with the visual script.

28. A computer system comprising:
a first retriever to retrieve a computer script from a pre-populated database, the computer script containing at least one component, the computer script formatted using a language including at least one of an Interactive Voice Response-eXtensible Markup Language (IVR-XML) and a character-delimited flat file; and
a generator to generate training data using the computer script, the training data formatted as a linear computer script.

29. The computer system of claim 28, wherein the pre-populated database includes at least one of a library status table, a voice talent table, a last index table, a scripts table, a components table, a category types table, and a categories table.

30. The computer system of claim 28, further comprising a second retriever to retrieve an audio file associated with the training data.

31. A computer system comprising:
a validator to validate a computer script, the computer script formatted using at least one of an Interactive Voice Response-eXtensible Markup Language (IVR-XML) and a character-delimited flat file; and
a message generator to generate a message prompt where an error is detected, the error including at least one of a data definition criteria, a linking criteria, and a storage criteria.

32. The computer system of claim 31, wherein the message prompt provides a text-based description describing how to fix the error so as to allow the computer script to run to completion.

33. An apparatus comprising:
means for creating a visual script containing a component that includes at least one of a function component, a decisional component, a speak component, and a capture component; and
means for converting the visual script to a computer script.

34. A machine-readable medium comprising instructions, which when implemented by one or more machines, cause the one or more machines to perform the following operations:
creating a visual script containing a component that includes at least one of a function component, a decisional component, a speak component, and a capture component; and
converting the visual script to a computer script.
